(19) United States
(12) Patent Application Publication
(10) Pub. No.: US 2026/0331788 A1
(43) Pub. Date: Oct. 22, 2026

(54) Antenna System, Radar, Terminal Device, and Vehicle End

(71) Applicant: Yinwang Intelligent Technologies Co., Ltd., Shenzhen (CN)

(72) Inventors: Zhiyuan Zhang, Shanghai (CN); Guanghong Chang, Shanghai (CN); Hongwei Li, Shanghai (CN)

(73) Assignee: Yinwang Intelligent Technologies Co., Ltd., Shenzhen (CN)

(21) Appl. No.: 19/720,383

(22) Filed: Jun. 25, 2026

Related U.S. Application Data
(63) Continuation of application No. PCT/CN2023/141532, filed on Dec. 25, 2023.

(51) Int. Cl. H01Q 25/00; H01Q 5/28

(52) U.S. Cl. CPC H01Q 25/002; H01Q 5/28

(57) ABSTRACT

An antenna system includes M transmit antennas and N receive antennas, where M and N are integers greater than 2. In a first direction, the M transmit antennas and the N receive antennas are unevenly arranged. The M transmit antennas include at least one first minimum value point, and the N receive antennas include at least one second minimum value point. Within a first angle range of a center point of a main lobe, a direction corresponding to the first minimum value point and a direction corresponding to the second minimum value point are different. The first minimum value point and the second minimum value point correspond to different directions within the first angle range of a main lobe beam.

### CROSS-REFERENCE TO RELATED APPLICATIONS

This is a continuation of International Patent Application No. PCT/CN2023/141532, filed on Dec. 25, 2023, the disclosure of which is hereby incorporated by reference in its entirety.

### TECHNICAL FIELD

The present disclosure relates to the field of radar technologies, and in particular, to an antenna system, a radar, a terminal device, and a vehicle end.

### BACKGROUND

A detection capability of a radar, especially a detection capability of the radar within a specific angle range in a beam direction of a main lobe of an array, is an important criterion for measuring radar detection performance. The detection capability of the radar includes angular resolution, an anti-interference capability, and the like. The angular resolution is inversely proportional to a beam width of the main lobe, and a side lobe suppression effect can directly reflect the anti-interference capability of the radar.

A spacing between adjacent antennas in an antenna array may be increased to decrease the beam width of the main lobe, and improve resolution of the radar. However, this manner compromises a field of view range of the radar, reduces an effective detection range of the radar, and further reduces a side lobe suppression effect, and is likely to introduce more interference.

Therefore, how to improve the detection capability of the radar within the specific angle range in the beam direction of the main lobe of the array is an urgent problem to be resolved currently.

### SUMMARY

Embodiments of the present disclosure provide an antenna system, a radar, a terminal device, and a vehicle end, to improve a detection capability of the radar in a specific angle range in a beam direction of a main lobe of an array.

According to a first aspect, an embodiment of the present disclosure provides an antenna system. The antenna system includes:

M transmit antennas and N receive antennas, where M and N are integers greater than 2.

In a first direction, a distance between adjacent antennas varies between two groups of adjacent antennas in the M transmit antennas, a distance between adjacent antennas varies between two groups of adjacent antennas in the N receive antennas, a distance between adjacent antennas in the M transmit antennas or the N receive antennas is an integer multiple of a first value, and the first value is related to a wavelength of an electromagnetic wave corresponding to an operating frequency of the antenna system.

A directional gain pattern corresponding to the M transmit antennas includes at least one first minimum value point, a directional gain pattern corresponding to the N receive antennas includes at least one second minimum value point, and the directional gain pattern is in the first direction.

A direction corresponding to the first minimum value point and a direction corresponding to the second minimum value point are different, and the direction corresponding to the first minimum value point and the direction corresponding to the second minimum value point are within a first angle range of a center point of a main lobe.

In this embodiment of the present disclosure, an antenna system is provided. In the first direction, a distance between adjacent antennas varies between two groups of adjacent antennas in the M transmit antennas of the antenna system, and a distance between adjacent antennas varies between two groups of adjacent antennas in the N receive antennas of the antenna system. It may be understood that in the first direction, the M transmit antennas and the N receive antennas are unevenly arranged. In the uneven arrangement manner, antennas with a relatively short adjacent spacing and antennas with a relatively long adjacent spacing are included. The antennas with a relatively short adjacent spacing can implement a good side lobe suppression effect and a large field of view range, and have a strong anti-interference capability. The antennas with a relatively long adjacent spacing can enable a width angle of a main lobe beam to be narrow, and have high detection resolution. Therefore, the uneven arrangement manner can implement a large field of view, high resolution, and an anti-interference capability in the first direction. A distance between adjacent antennas in the M transmit antennas or the N receive antennas is an integer multiple of the first value, and the first value is related to a wavelength of an electromagnetic wave corresponding to an operating frequency of the antenna system. In this way, no grating lobe appears within a field of view range of the antenna in the first direction, thereby avoiding a phenomenon that a measurement result of the antenna system is not unique due to the grating lobe. For ease of description, a directional gain pattern corresponding to the M transmit antennas may be referred to as a first directional gain pattern, and a directional gain pattern corresponding to the N receive antennas may be referred to as a second directional gain pattern. The first directional gain pattern includes at least one first minimum value point, and the second directional gain pattern includes at least one second minimum value point. It may be understood that any minimum value point in the first directional gain pattern may be referred to as a first minimum value point, and any minimum value point in the second directional gain pattern may be referred to as a second minimum value point. That the direction corresponding to the first minimum value point and the direction corresponding to the second minimum value point are different may be understood that any minimum value point in the first directional gain pattern is different from any minimum value point in the second directional gain pattern. The direction corresponding to the first minimum value point and the direction corresponding to the second minimum value point are within a first angle range of a center point of a main lobe. The center point of the main lobe may be understood as a maximum radiation direction of a main lobe beam, and the first angle range of the center point of the main lobe may be understood as that the center point of the main lobe is used as an angle range corresponding to a middle value of an angle range (for example, 0° is a middle value of −20° to) 20°. Therefore, the direction corresponding to the first minimum value point and the direction corresponding to the second minimum value point are within the first angle range of the center point of the main lobe. It may be understood that maximum radiation directions of main lobe beam in the first directional gain pattern and the second directional gain pattern are the same (for example, both are) 0°, and a value range of the direction corresponding to the first minimum value point and a value range of the direction corresponding to the second minimum value point are the same. For example, the value ranges are both −20° to 20°. Because a directional gain pattern of a virtual array is obtained by multiplying gains in the first gain pattern and the second gain pattern in a same direction, the direction corresponding to the first minimum value point and the direction corresponding to the second minimum value point are different within the first angle range of the main lobe beam, so that a maximum value point in the first gain pattern and a maximum value point in the second gain pattern can be staggered, to avoid multiplication of the maximum value points. In this way, a directional gain pattern of a virtual array corresponding to the M transmit antennas and the N receive antennas has a good side lobe suppression effect within the first angle range of the main lobe beam, thereby improving a detection capability of a radar within a specific angle range in a beam direction of a main lobe of an array.

In a possible implementation, the directional gain pattern corresponding to the M transmit antennas includes at least one first maximum value point, the directional gain pattern corresponding to the N receive antennas includes at least one second maximum value point, and the directional gain pattern is in the first direction.

A direction corresponding to the first maximum value point and a direction corresponding to the second maximum value point are different, and the direction corresponding to the first maximum value point and the direction corresponding to the second maximum value point are within the first angle range of the center point of the main lobe.

In this implementation of the present disclosure, within the first angle range of the beam direction of the main lobe, the direction corresponding to the first maximum value point and the direction corresponding to the second maximum value point are different, so that multiplication of the first maximum value point and the second maximum value point can be avoided, and a high-gain side lobe beam appears in a corresponding directional gain pattern of a virtual array. In this way, a good side lobe suppression effect is implemented, thereby improving a detection capability of the radar within a specific angle range in the beam direction of the main lobe of the array.

In a possible implementation, that the first value is related to the wavelength of the electromagnetic wave corresponding to the operating frequency of the antenna system is specifically: The first value a meets the following condition: a≥λ/2, where A represents the wavelength of the electromagnetic wave corresponding to the operating frequency of the antenna system.

In this implementation of the present disclosure, the first value a meets the following condition: a≥λ/2, where λ represents the wavelength of the electromagnetic wave corresponding to the operating frequency of the antenna system. Because a spacing (in the first direction) between adjacent antennas in the M transmit antennas and the N receive antennas is a multiple of the first value a, a field of view range corresponding to the M transmit antennas or the N receive antennas meets the following relationship:

$${δ}_{m} = {sin}^{- 1} ( \pm \frac{λ}{a} + sin {δ}_{m} )$$

Herein, δₘ represents two boundary values of the field of view, λ is the wavelength of the electromagnetic wave, and a is the first value. For example, when a is equal to λ/2, it is derived through calculation that δₘ is equal to 90° or −90°, indicating that a field of view range is from −90° to 90°. Similarly, for example, when a is equal to 0.7λ, it may be calculated that δₘ is equal to 45.8° or −45.8°, indicating that a field of view range is from −45.8° to 45.8°. It can be learned that the field of view range is related to a value of a. When a=90°, a corresponding field of view range is 90°. As the value of a increases, the corresponding field of view range decreases. It can be learned that, when the value of the first value a meets a condition: a≥λ/2, the corresponding field of view range is from to −90° to 90°. In this way, the foregoing antenna system can meet requirements of most application scenarios on a field of view range.

Optionally, a value of the first value a may be less than λ/2. In this case, a corresponding field of view range is outside the range from −90° to 90°.

In a possible implementation, the directional gain pattern corresponding to the M transmit antennas includes two first minimum value points adjacent to the main lobe, and directions corresponding to the two first minimum value points are different.

The directional gain pattern corresponding to the N receive antennas includes two second minimum value points adjacent to the main lobe, and directions corresponding to the two second minimum value points are different.

In this implementation of the present disclosure, the directions corresponding to the two first minimum value points included in the directional gain pattern corresponding to the M transmit antennas are different, and the directions corresponding to the two second minimum value points included in the directional gain pattern corresponding to the N receive antennas are different. It may be understood that directions corresponding to any two first minimum value points or any two second minimum value points are different.

In a possible implementation, the first minimum value point or the second minimum value point meets the following relationship:

$$\{ \begin{matrix}0 < ‖ sin ( {φ}_{k + 1} ) \vert - \vert sin ( {φ}_{k} ) ‖ \leq 0.1 \\ {φ}_{k} < {φ}_{k + 1} \\ {φ}_{k + 1} < {γ}_{m} \\ or \\ {γ}_{m} < {φ}_{k}\end{matrix}$$

Herein, φₖ₊₁ or φₖ respectively represents a direction corresponding to a (k+1)^{th} target minimum value point and a direction corresponding to a k^{th} target minimum value point, the target minimum value point is the first minimum value point or the second minimum value point, γₘ represents a direction corresponding to a center point of a main lobe beam. k∈[1, P−1], where P is a quantity of the target minimum value points. When the target minimum value point is the first minimum value point, γₘ represents a direction corresponding to the center point of the main lobe beam in the directional gain pattern corresponding to the M transmit antennas. When the target minimum value point is the second minimum value point, γₘ represents a direction corresponding to the center point of the main lobe beam in the directional gain pattern corresponding to the N receive antennas.

In this implementation of the present disclosure, the first minimum value point or the second minimum value point meets the foregoing condition, and the target minimum value point is the first minimum value point or the second minimum value point. For example, the target minimum value point is the first minimum value point. φₖ₊₁ or φₖ respectively represents the direction corresponding to the (k+1)^{th} first minimum value point and the direction corresponding to the k^{th} first minimum value point, and γₘ represents a direction corresponding to the center point of the main lobe beam. It may be understood that γₘ represents a maximum radiation direction of the main lobe beam in the directional gain pattern corresponding to the M transmit antennas, or γₘ represents a maximum radiation direction of the main lobe beam in the directional gain pattern corresponding to the N receive antennas. When the target minimum value point is the first minimum value point, γₘ represents the maximum radiation direction of the main lobe beam in the directional gain pattern of the M transmit antennas. When the target minimum value point is the second minimum value point, γₘ represents the maximum radiation direction of the main lobe beam in the directional gain pattern of the N receive antennas. P is a quantity of target minimum value points. When the target minimum value point is the first minimum value point, P is a quantity of first minimum value points. When the target minimum value point is the second minimum value point, P is a quantity of second minimum value points.

0<∥sin(φₖ₊₁)|−|sin(φₖ)∥≤0.1 represents that a difference between sine values of directions corresponding to two adjacent target minimum value points belongs to (0, 0.1]. The difference between the sine values belonging to (0, 0.1] can avoid a case in which the directions corresponding to the two target minimum value points overlap or are excessively far away from each other, and consequently, a high-gain side lobe beam appears in the directional gain pattern of the virtual array, and detection resolution is reduced. Therefore, limiting the difference between the sine values of the directions corresponding to the target minimum value points to (0, 0.1] can improve a detection capability of the radar within a specific angle range in the beam direction of the main lobe of the array.

In the foregoing relationship

$$\begin{matrix}{φ}_{k} < {φ}_{k + 1} \\ {φ}_{k + 1} < {γ}_{m} \\ or \\ {γ}_{m} < {φ}_{k}\end{matrix} ,$$

there are two cases. Case 1: φₖ<φₖ₊₁<γₘ, indicating that the directions corresponding to the target minimum value points are all less than the direction corresponding to the center point of the main lobe beam. Case 2: γₘ<φₖ<φₖ₊₁, indicating that the directions corresponding to the target minimum value points are all greater than the direction corresponding to the center point of the main lobe beam. The target minimum value points in any case meet the relationship 0<∥sin(φₖ₊₁)|−|sin(φₖ)∥≤0.1.

In a possible implementation, φ₁, φ_{P}, and γₘ meet the following relationship:

$$\{ \begin{matrix}{φ}_{P} < {γ}_{m} , 0 < \vert \vert sin ( {φ}_{P} ) \vert - \vert sin ( {γ}_{m} ) \vert \vert < 0.15 \\ {γ}_{m} < {φ}_{1} , 0 < \vert \vert sin ( {φ}_{1} ) \vert - \vert sin ( {γ}_{m} ) \vert \vert < 0.15\end{matrix}$$

Herein, φ₁ is a direction corresponding to a 1^{st} minimum value point in the target minimum value points, and φ_{P} is a direction corresponding to a P^{th} minimum value point in the target minimum value points.

In this implementation of the present disclosure, φ₁ is the direction corresponding to the 1^{st} minimum value point in the target minimum value points, and Op is the direction corresponding to the P^{th} minimum value point in the target minimum value points. When φ_{P}<γₘ, φ_{P} is a target minimum value point adjacent to the main lobe beam. When γₘ<φ₁, φ₁ is a target minimum value point adjacent to the main lobe beam. φ_{P}<γₘ, 0<∥sin(φ_{P})|−|sin(γₘ)∥<0.15 or γₘ<φ₁, 0<∥sin(φ₁)|−|sin(γₘ)∥<0.15 may be understood as that a difference between a sine value of the direction corresponding to the center point of the main lobe beam and a sine value of the direction corresponding to the target minimum value point adjacent to the main lobe beam belongs to (0, 0.15). A width of the main lobe beam affects the difference between the sine value of the direction corresponding to the center point of the main lobe beam and the sine value of the direction corresponding to the target minimum value point adjacent to the main lobe beam. Therefore, by limiting the difference to belong to (0, 0.15), the width of the main lobe beam can be within a specific range, and an excessively wide width of the main lobe beam can be avoided, thereby ensuring resolution of the antenna system, and further improving a detection capability of the radar within a specific angle range in the beam direction of the main lobe of the array.

In a possible implementation, A is determined based on the direction corresponding to the at least one first minimum value point and the direction corresponding to the at least one second minimum value point, and A meets the following relationship:

$$\{ \begin{matrix}A = \{ {α}_{1} , {α}_{2} , {α}_{3} , … , {α}_{P 3} \} \\ {α}_{x} < {α}_{x + 1} \\ {γ}_{m} < {α}_{1} \\ or \\ {α}_{P 3} < {γ}_{m} \\ x ∈ [ 1 , P3 ‐ 1 ] \\ 0 < \vert \vert sin ( {α}_{x + 1} ) \vert - \vert sin ( {α}_{x} ) \vert \vert \leq 0.09\end{matrix}$$

Herein, P3 is a sum of the quantity of the first minimum value points and a quantity of the second minimum value points.

In this implementation of the present disclosure, A is determined based on the direction corresponding to the at least one first minimum value point and the direction corresponding to the at least one second minimum value point. A={α₁, α₂, α₃, . . . , α_{P3}} and αₓ<αₓ₊₁ may be understood that values in A are arranged in ascending order. P3 is a sum of the quantity of first minimum value points and the quantity of second minimum value points. Further, on a basis that A is determined based on the direction corresponding to the at least one first minimum value point and the direction corresponding to the at least one second minimum value point, it may be understood that A={α₁, α₂, α₃, . . . , α_{P3}} is obtained by re-sorting the direction corresponding to the at least one first minimum value point and the direction corresponding to the at least one second minimum value point in ascending order. 0<∥sin(αₓ₊₁)|−|sin(αₓ)∥≤0.09 represents that a difference between sine values of two adjacent directions in A belongs to (0, 0.09]. By limiting a value range of a difference between sine values of two adjacent directions in A, a value range of the difference between the direction corresponding to the first minimum value point and the direction corresponding to the second minimum value point is limited to be within a specific range. In this way, within the first angle range of the center point of the main lobe beam, a side lobe suppression effect is good in the directional gain pattern of the virtual array corresponding to the M transmit antennas and the N receive antennas, thereby improving a detection capability of the radar within a specific angle range in the beam direction of the main lobe of the array.

In a possible implementation, M=N=4.

In this implementation of the present disclosure, M and N each are equal to 4, that is, the antenna system includes four transmit antennas and four receive antennas. In this way, when the antenna system includes a limited quantity of antennas, the antenna system can have a good side lobe suppression effect, high detection resolution, and no grating lobe within a field of view range. This reduces costs and a size of the antenna system, so that the antenna system can be more widely used in various scenarios.

In a possible implementation, in the first direction, a ratio of distances between adjacent antennas among all groups of adjacent antennas in the M transmit antennas is any one of the following: 6:4:5 or 5:4:6; and a ratio of distances between adjacent antennas among all groups of adjacent antennas in the N receive antennas is any one of the following: 4:3:5 or 5:3:4.

Alternatively, a ratio of distances between adjacent antennas among all groups of adjacent antennas in the M transmit antennas is any one of the following: 9:8:7 or 7:8:9; and a ratio of distances between adjacent antennas among all groups of adjacent antennas in the N receive antennas is any one of the following: 7:5:6 or 6:5:7.

Alternatively, a ratio of distances between adjacent antennas among all groups of adjacent antennas in the M transmit antennas is any one of the following: 4:3:5 or 5:3:4; and a ratio of distances between adjacent antennas among all groups of adjacent antennas in the N receive antennas is any one of the following: 6:4:5 or 5:4:6.

Alternatively, a ratio of distances between adjacent antennas among all groups of adjacent antennas in the M transmit antennas is any one of the following: 7:5:6 or 6:5:7; and a ratio of distances between adjacent antennas among all groups of adjacent antennas in the N receive antennas is any one of the following: 9:8:7 or 7:8:9.

In this implementation of the present disclosure, a plurality of arrangement manners of the four transmit antennas and the four receive antennas in the antenna system in the first direction are shown. In the first direction, that the ratio of distances between adjacent antennas among all groups of adjacent antennas in the four transmit antennas is any one of the following: 6:4:5 or 5:4:6; and the ratio of distances between adjacent antennas among all groups of adjacent antennas in the four receive antennas is any one of the following: 4:3:5 or 5:3:4 may be understood that the antenna system includes the four transmit antennas and the four receive antennas, and in the first direction, arrangement manners of the four transmit antennas and the four receive antennas in the antenna system includes: A ratio of distances between adjacent antennas among all groups of adjacent antennas in the four transmit antennas is 6:4:5, and a ratio of distances between adjacent antennas among all groups of adjacent antennas in the four receive antennas is 4:3:5. Alternatively, a ratio of distances between adjacent antennas among all groups of adjacent antennas in the four transmit antennas is 6:4:5, and a ratio of distances between adjacent antennas among all groups of adjacent antennas in the four receive antennas is 5:3:4. Alternatively, a ratio of distances between adjacent antennas among all groups of adjacent antennas in the four transmit antennas is 5:4:6, and a ratio of distances between adjacent antennas among all groups of adjacent antennas in the four receive antennas is 4:3:5. Alternatively, a ratio of distances between adjacent antennas among all groups of adjacent antennas in the four transmit antennas is 6:4:5, and a ratio of distances between adjacent antennas among all groups of adjacent antennas in the four receive antennas is 4:3:5.

Optionally, a minimum common factor of spacings between the groups of adjacent antennas is the first value a.

It should be noted that, in the first direction, any arrangement manner of the antenna system may enable a direction of any minimum value point in a directional gain pattern corresponding to the four transmit antennas to be different from a direction of any minimum value point in a directional gain pattern corresponding to the four receive antennas. In addition, the antenna system has a good side lobe suppression effect, high detection resolution, and no grating lobe within a field of view. Therefore, any arrangement manner can improve a detection capability of the radar within a specific angle range in the beam direction of the main lobe of the array.

In a possible implementation, in the second direction, a distance between adjacent antennas varies between two groups of adjacent antennas in the M transmit antennas, and a distance between adjacent antennas in the M transmit antennas is an integer multiple of a second value.

The second value is related to the wavelength of the electromagnetic wave corresponding to the operating frequency of the antenna system, and the second direction is perpendicular to the first direction.

In this implementation of the present disclosure, in the second direction, a distance between adjacent antennas varies between two groups of adjacent antennas in the M transmit antennas. It may be understood that the M transmit antennas are also unevenly arranged in the second direction. Antennas with a relatively short spacing and antennas with a relatively long spacing are included in the uneven arrangement manner. The antennas with the relatively short spacing can implement a good side lobe suppression effect and a large field of view range, and have a strong anti-interference capability. The antennas with the relatively long spacing can enable a width angle of the main lobe beam to be narrow, and have high detection resolution. Therefore, the uneven arrangement manner can implement a large field of view, high resolution, and a strong anti-interference capability in the second direction. A distance between adjacent antennas in the M transmit antennas is an integer multiple of the second value, and the second value is related to the wavelength of the electromagnetic wave. In this way, no grating lobe appears within a field of view range of the antenna in the second direction, thereby avoiding a phenomenon that a measurement result of the antenna system is not unique due to the grating lobe.

In a possible implementation, that the second value is related to the wavelength of the electromagnetic wave corresponding to the operating frequency of the antenna system is specifically: The second value b meets the following condition: b≥λ/2, where λ represents the wavelength of the electromagnetic wave.

In this implementation of the present disclosure, the second value b meets the following condition: b≥λ/2, where λ represents the wavelength of the electromagnetic wave corresponding to the operating frequency of the antenna system. Because a spacing (in the second direction) between adjacent antennas in the M transmit antennas is a multiple of the second value b, a field of view range corresponding to the M transmit antennas meets the following relationship:

$${δ}_{m} = {sin}^{- 1} ( \pm \frac{λ}{b} + sin {δ}_{m} )$$

Herein, δₘ represents two boundary values of the field of view, λ is the wavelength of the electromagnetic wave, and b is the second value. For example, when b is equal to λ/2, it is derived through calculation that δₘ is equal to 90° or −90°, indicating that a field of view range is from −90° to 90°. Similarly, for example, when b is equal to 0.7λ, it may be calculated that δₘ is equal to 45.8° or −45.8°, indicating that a field of view range is −45.8° to 45.8°. It can be learned that the field of view range is related to a value of b. When b=90°, a corresponding field of view range is 90°. As the value of b increases, the corresponding field of view range decreases. It can be learned that, when the value of the second value b meets a condition: b≥λ/2, the corresponding field of view range is less than or equal to −90° to 90°. In this way, the foregoing antenna system can meet requirements of most application scenarios on a field of view range.

Optionally, a value of the second value b may be less than 2/2. In this case, a corresponding field of view range is greater than −90° to 90°.

In a possible implementation, b=0.7λ.

In this implementation of the present disclosure, b=0.7λ, so that the field of view range is −45.8° to 45.8°. In this way, the field of view range in the second direction is moderate, to meet requirements of most application scenarios, and more capabilities can be concentrated in a radiation direction of the main lobe beam, to improve a detection capability of the radar system in the second direction.

In a possible implementation, M=4. In the second direction, the ratio of distances between adjacent antennas among all groups of adjacent antennas in the M transmit antennas is 1:0:3 or 3:0:1.

In this implementation of the present disclosure, an arrangement manner of the four transmit antennas in the first direction in the antenna system is shown. In the second direction, the ratio of distances between adjacent antennas among all groups of adjacent antennas in the four transmit antennas is any one of the following: 1:0:3 or 3:0:1.

In a possible implementation, M=4. In the second direction, the ratio of distances between adjacent antennas among all groups of adjacent antennas in N receive antennas is 1:0:3 or 3:0:1.

Optionally, the ratio of distances between adjacent antennas among all groups of adjacent antennas in the four transmit antennas in the second direction may alternatively be any one of the following values: 9:8:7, 7:8:9, 6:4:5, or 5:4:6.

Alternatively, the ratio of distances between adjacent antennas among all groups of adjacent antennas in the four transmit antennas in the second direction may alternatively be any one of the following values: 7:5:6, 6:5:7, 4:3:5, or 5:3:4.

Optionally, a minimum common factor of spacings between the groups of adjacent antennas is the second value b.

In a possible implementation, M=N=4. In the second direction, a ratio of distances between adjacent antennas among all groups of adjacent antennas in the M transmit antennas is any one of the following: 6:4:5 or 5:4:6; and a ratio of distances between adjacent antennas among all groups of adjacent antennas in the N receive antennas is any one of the following: 4:3:5 or 5:3:4.

Alternatively, a ratio of distances between adjacent antennas among all groups of adjacent antennas in the M transmit antennas is any one of the following: 9:8:7 or 7:8:9; and a ratio of distances between adjacent antennas among all groups of adjacent antennas in the N receive antennas is any one of the following: 7:5:6 or 6:5:7.

Alternatively, a ratio of distances between adjacent antennas among all groups of adjacent antennas in the M transmit antennas is any one of the following: 4:3:5 or 5:3:4; and a ratio of distances between adjacent antennas among all groups of adjacent antennas in the N receive antennas is any one of the following: 6:4:5 or 5:4:6.

Alternatively, a ratio of distances between adjacent antennas among all groups of adjacent antennas in the M transmit antennas is any one of the following: 7:5:6 or 6:5:7; and a ratio of distances between adjacent antennas among all groups of adjacent antennas in the N receive antennas is any one of the following: 9:8:7 or 7:8:9.

It should be noted that, in the second direction, any arrangement manner of the antenna system may enable a direction of any minimum value point in a directional gain pattern corresponding to the four transmit antennas to be different from a direction of any minimum value point in a directional gain pattern corresponding to the four receive antennas. In addition, the antenna system has a good side lobe suppression effect, high detection resolution, and no grating lobe within a field of view, thereby improving a detection capability of the radar within a specific angle range in the beam direction of the main lobe of the array.

In a possible implementation, the first angle range [x, y] and the beam width c of the main lobe meet the following condition: 2c≤|y−x|≤12c.

In this implementation of the present disclosure, the first angle range [x, y] and the beam width c of the main lobe is limited to meet the relationship 2c≤|y−x|≤12c. This is equivalent to that a width of the first angle range is greater than or equal to twice the beam width of the main lobe, and is less than or equal to 10 times the beam width of the main lobe.

According to a second aspect, an embodiment of the present disclosure provides a chip. The chip includes the antenna system according to the first aspect or any possible implementation of the first aspect.

According to a third aspect, an embodiment of the present disclosure provides a radar or a radar system. The radar or the radar system includes the transmit system according to the first aspect or any possible implementation of the first aspect, or includes the chip according to the second aspect. It should be noted that there may be a smart sensor that is integrated with a plurality of sensors. When the smart sensor includes a millimeter-wave detection function, the smart sensor may also be referred to as a millimeter-wave radar or a millimeter-wave radar system.

According to a fourth aspect, an embodiment of the present disclosure provides a terminal device. The terminal device includes the transmit system according to the first aspect or any possible implementation of the first aspect, or includes the chip according to the second aspect, or includes the radar or the radar system according to the third aspect.

According to a fifth aspect, an embodiment of the present disclosure provides a vehicle end. The vehicle end includes the transmit system according to the first aspect or any possible implementation of the first aspect, or includes the chip according to the second aspect, or includes the radar or the radar system according to the third aspect, or includes the terminal device according to the fourth aspect.

In this embodiment of the present disclosure, in a first direction, M transmit antennas and N receive antennas are unevenly arranged. Antennas with a relatively short spacing and antennas with a relatively long spacing are included in the uneven arrangement manner. The antennas with the relatively short spacing can implement a good side lobe suppression effect and a large field of view range, and have a strong anti-interference capability. The antennas with the relatively long spacing can enable a width angle of the main lobe beam to be narrow, and have high detection resolution. Therefore, the uneven arrangement manner can implement a large field of view, high resolution, and a strong anti-interference capability in the first direction. A distance between adjacent antennas in the M transmit antennas or the N receive antennas is an integer multiple of a first value, and the first value is related to a wavelength of an electromagnetic wave corresponding to an operating frequency of the antenna system. In this way, no grating lobe appears within a field of view range of the antenna in the first direction, thereby avoiding a phenomenon that a measurement result of the antenna system is not unique due to the grating lobe. For ease of description, a directional gain pattern corresponding to the M transmit antennas may be referred to as a first directional gain pattern, and a directional gain pattern corresponding to the N receive antennas may be referred to as a second directional gain pattern. Because a directional gain pattern of a virtual array is obtained by multiplying gains in the first gain pattern and the second gain pattern in a same direction, a direction corresponding to a first minimum value point and a direction corresponding to a second minimum value point are different within a first angle range of the main lobe beam, so that a maximum value point in the first gain pattern and a maximum value point in the second gain pattern can be staggered, to avoid multiplication of the maximum value points. In this way, a directional gain pattern of a virtual array corresponding to the M transmit antennas and the N receive antennas has a good side lobe suppression effect within the first angle range of the main lobe beam, thereby improving a detection capability of a radar within a specific angle range in a beam direction of a main lobe of an array.

### BRIEF DESCRIPTION OF DRAWINGS

To describe the technical solutions in embodiments of the present disclosure more clearly, the following briefly describes the accompanying drawings used in embodiments of the present disclosure. It is clear that, the accompanying drawings described below show merely some embodiments of the present disclosure, and a person of ordinary skill in the art may still derive other drawings from these accompanying drawings without creative efforts.

FIG. 1 is a diagram of radar distribution according to an embodiment of the present disclosure;

FIG. 2 is a diagram of an architecture of a radar according to an embodiment of the present disclosure;

FIG. 3 is a diagram of an architecture of a radar according to an embodiment of the present disclosure;

FIG. 4 is a diagram of a structure of a first antenna system according to an embodiment of the present disclosure;

FIG. 5A is a diagram of a first gain pattern according to an embodiment of the present disclosure;

FIG. 5B is a diagram of a second gain pattern according to an embodiment of the present disclosure;

FIG. 6A to FIG. 6D are diagrams of several antenna systems according to embodiments of the present disclosure;

FIG. 7A to FIG. 7D are diagrams of several antenna systems according to embodiments of the present disclosure;

FIG. 8A to FIG. 8D are diagrams of several antenna systems according to embodiments of the present disclosure;

FIG. 9A to FIG. 9D are diagrams of several antenna systems according to embodiments of the present disclosure;

FIG. 10A is a diagram of a first directional gain pattern according to an embodiment of the present disclosure;

FIG. 10B is a diagram of a second directional gain pattern according to an embodiment of the present disclosure;

FIG. 10C is a diagram of a third directional gain pattern according to an embodiment of the present disclosure;

FIG. 10D is a diagram of a fourth directional gain pattern according to an embodiment of the present disclosure;

FIG. 10E is a diagram of a fifth directional gain pattern according to an embodiment of the present disclosure;

FIG. 11 is a diagram of a structure of a second antenna system according to an embodiment of the present disclosure;

FIG. 12 is a diagram of a structure of a third antenna system according to an embodiment of the present disclosure;

FIG. 13A and FIG. 13B are diagrams of several antenna systems according to embodiments of the present disclosure;

FIG. 14A and FIG. 14B are diagrams of several antenna systems according to embodiments of the present disclosure;

FIG. 15 is a diagram of an antenna system according to an embodiment of the present disclosure; and

FIG. 16 is a diagram of an antenna system according to an embodiment of the present disclosure.

### DESCRIPTION OF EMBODIMENTS

To make objectives, technical solutions, and advantages of the present disclosure clearer, the following describes embodiments of the present disclosure with reference to accompanying drawings in embodiments of the present disclosure.

The terms “first”, “second”, and the like in the specification, claims, and accompanying drawings of the present disclosure are used to distinguish between different objects, but are not used to describe a specific sequence. In addition, terms such as “include” and “have” and any other variants thereof are intended to cover a non-exclusive inclusion. For example, processes, methods, systems, products, or devices that include a series of steps or units are not limited to listed steps or units, but optionally further include steps or units that are not listed, or optionally further include other steps or units inherent to these processes, methods, products, or devices.

“Embodiments” mentioned herein mean that specific features, structures, or characteristics described in combination with embodiments may be included in at least one embodiment of the present disclosure. The phrase shown in various locations in the specification may not necessarily refer to a same embodiment, and is not an independent or optional embodiment exclusive from another embodiment. It may be explicitly and implicitly understood by a person skilled in the art that embodiments described in this specification may be combined with other embodiments.

It should be understood that in the present disclosure, “at least one item (piece)” means one or more, “a plurality of” means two or more, “at least two items (pieces)” means two, three, or more, and “and/or” describes an association relationship for describing associated objects and indicates that three relationships may exist. For example, “A and/or B” may indicate the following three cases: Only A exists, only B exists, and both A and B exist. A and B each may be in a singular or plural form. The character “/” generally indicates an “or” relationship between the associated objects. “At least one of the following items (pieces)” or a similar expression thereof refers to any combination of these items, including any combination of singular items (pieces) or plural items (pieces). For example, at least one of a, b, or c may indicate a, b, c, a and b, a and c, b and c, or a, b, and c, where a, b, and c may be singular or plural.

As described in the background, how to improve a detection capability of a radar within a specific angle range in a beam direction of a main lobe of an array is an urgent problem to be resolved currently. The present disclosure relates to the field of millimeter-wave radar technologies, and provides an antenna system, a radar, a terminal device, and a vehicle end, to improve a detection capability of a radar within a specific angle range in a beam direction of a main lobe of an array.

To describe the solutions of the present disclosure more clearly, the following first describes some knowledge related to a radar and an antenna pattern. The antenna pattern is an important graph for measuring performance of an antenna (including an antenna for a radar system).

### (1) Radar

Radar is short for “radio detection and ranging.”. The radar is used to discover a target and determine a spatial position of the target by using a radio method.

A detection medium of the radar is an electromagnetic wave, and the radar implements detection of a target, for example, distance measurement, speed measurement, or azimuth measurement, through transmission and reception of the electromagnetic wave. The radar can implement distance detection on the target based on time of flight of the electromagnetic wave. The time of flight is a time difference between receiving and transmission of the electromagnetic wave. The radar transmits an electromagnetic wave signal, receives an echo signal of the electromagnetic wave signal, and may implement distance detection on the target based on a time difference between the received echo signal and the transmitted electromagnetic wave signal and a propagation speed of the electromagnetic wave. A distance between the radar and the target may be determined according to the following formula: s=c*t/2, where s indicates the distance of the target, t indicates the time of flight, namely, a time period from transmission of the electromagnetic wave signal from the radar to receiving of the echo signal, and c indicates the speed of light.

The radar implements speed measurement on the target based on a Doppler effect. A principle of the Doppler effect is as follows: When a vibration source like a sound, light, and a radio wave moves relative to an observer at a relative speed, a frequency of vibration received by the observer is different from a frequency generated by the vibration source. When the electromagnetic wave transmitted by the radar moves relative to a detected object, a frequency of the echo signal is different from a frequency of the transmitted electromagnetic wave signal. When the target approaches an antenna of the radar, the frequency of the echo signal is higher than the frequency of the transmitted electromagnetic wave signal. When the target moves away from an antenna of the radar, the frequency of the echo signal is lower than the frequency of the transmitted electromagnetic wave signal. A frequency change caused by the Doppler effect is referred to as a Doppler frequency shift, which is proportional to the relative speed and inversely proportional to the vibration frequency. Therefore, a frequency difference between the transmitted electromagnetic wave signal and the echo signal is detected, so that a moving speed of the target relative to the radar, namely, the relative speed of the target relative to the radar, can be measured.

The radar may measure an azimuth by using an amplitude method, a phase method, or the like. The amplitude method is used to measure an azimuth by using an amplitude value of an echo signal received through an antenna, and a change rule of the amplitude value depends on an antenna pattern and a scanning manner of the antenna. The phase method is used to measure an azimuth by using a phase difference between echo signals received through a plurality of antenna elements. For example, the radar receives, by using an antenna array, echo signals reflected by a same target, and calculates an azimuth of the target based on a phase difference of the echo signals.

A detection medium of a millimeter-wave radar is an electromagnetic wave within a specific wavelength range, for example, a microwave. Currently, a millimeter wave and a centimeter wave (for example, a centimeter wave in a 24 gigahertz (GHz) frequency band) adjacent to the millimeter wave in wave bands are commonly used. The millimeter wave is an electromagnetic wave with a wavelength of 1 to 10 millimeters (mm), and a wavelength of an electromagnetic wave in the 24 GHz frequency band is slightly greater than 10 mm. Because a wavelength of the detection medium of the millimeter-wave radar is in an overlapped wavelength range of the microwave and a far infrared wave, the detection medium of the millimeter-wave radar has characteristics of two spectrums. According to a wave propagation theory, a higher frequency indicates a shorter wavelength, a higher resolution, and a stronger penetration capability, while in this case, a loss in a propagation process is larger, and a transmission distance is shorter. On the contrary, a lower the frequency indicates a longer wavelength, a stronger diffraction capability, and a longer transmission distance. Therefore, compared with the microwave, the detection medium of the millimeter-wave radar has a high resolution, good directivity, a strong anti-interference capability, and good detection performance. Compared with infrared, the detection media of the millimeter-wave radar has lower atmospheric attenuation, better penetration to smoke and dust, and is less affected by weather. Therefore, the millimeter-wave radar is increasingly widely used in a plurality of fields such as intelligent vehicles, drones, intelligent transportation, and industrial automation.

On a basis of a detection distance, the radar can be classified into a long-range radar (LRR), a medium-range radar (MRR), and a short-range radar (SRR). The LRR has a high requirement for a detection distance, and has a low requirement for a width of a detection angular domain. The SRR has a low requirement on a detection range, and has a high requirement on a width of a detection angular domain. A requirement of the MRR on a detection range and a width of an angular domain may be understood as being between that of the LRR and that of the SRR. For example, the detection range of the LRR may be greater than 200 meters, and the width of the angular domain may be ±15°; the detection range of the MRR may be within 100 meters, and the width of the angular domain may be ±45°; and the detection range of the SRR may be within 60 meters, and the width of the angular domain may be ±80°. During use, different types of radars may be mounted at different locations of a vehicle body based on a function requirement of autonomous driving and a use status of another sensor. A quantity and types of the radars may be selected based on a requirement.

### (2) Antenna Pattern

The antenna pattern is also referred to as a directional gain pattern, a radiation pattern, or a far-field pattern. The antenna pattern is a pattern in which relative field strength (a normalized modulus value) of a radiation field of an antenna changes with a direction at a specific distance from the antenna, and is usually represented by two planar antenna patterns that are perpendicular to each other in a maximum radiation direction of the antenna.

The antenna pattern includes a plurality of radiation beams, which can be classified into a main lobe, a side lobe (or minor lobe), and a grating lobe.

A radiation beam with maximum radiation strength is referred to as a main lobe. An included angle between two points at which radiation strength is decreased by 3 decibels (dB) (power density is decreased by half) on two sides of a maximum radiation direction of the main lobe (a maximum radiation direction of the main lobe can be) 0° is defined as a beam width (also referred to as a lobe width, a beam width of a main lobe, or a half-power angle). The beam width of the main lobe is related to measurement resolution. For example, a wider beam width of the main lobe indicates lower measurement resolution. On the contrary, a narrower beam width of the main lobe indicates higher measurement resolution. In addition, the beam width of the main lobe is related to directivity of the antenna. A narrower main lobe beam indicates better directivity, a longer effective distance, and a stronger anti-interference capability. Therefore, a detection capability of the antenna can be improved by decreasing the beam width of the main lobe.

A small beam next to the main lobe is referred to as a side lobe (or minor lobe). Radiation strength of the side lobes is related to ease of interference. For example, if the radiation strength of the side lobe is higher, an angle corresponding to the side lobe is more likely to be interfered with. As a result, a measurement result is inaccurate. On the contrary, if the radiation strength of the side lobe is lower, an angle corresponding to the side lobe is less likely to be interfered with. As a result, a measurement result is more accurate. Therefore, the radiation strength of the side lobe can be suppressed to improve an anti-interference capability of the antenna, which is referred to as side lobe suppression. A better side lobe suppression effect indicates lower radiation strength of the side lobe and a stronger anti-interference capability of the antenna. On the contrary, a poorer side lobe suppression effect indicates higher radiation strength of the side lobe and a weaker anti-interference capability of the antenna.

Radiation lobes, except the main lobe, whose strength is similar to that of the main lobe are formed due to in-phase superposition of field strength in other directions, which are referred to as grating lobes. Occurrence of the grating lobe causes a measurement result to be no longer unique, and affects normal working of the antenna. Therefore, the grating lobe should be avoided within a field of view range.

The foregoing descriptions of the technical terms are optionally used in the following embodiments.

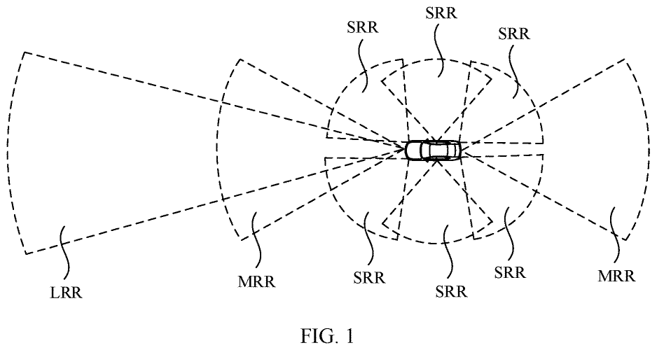

FIG. 1 is a diagram of radar distribution according to an embodiment of the present disclosure.

FIG. 1 shows possible mounting locations of several types of radars. The mounting locations are merely examples, and during actual use, more or fewer radars may be selected, and the types may also be adjusted.

As shown in FIG. 1, an LRR may be mounted on the front of a vehicle body and serve as a forward radar; an MRR may be mounted on the front or the rear of the vehicle body and serve as a forward radar or a backward radar; and an SRR may be mounted on a side of the vehicle body or four corners of the vehicle body and serve as a side radar or a corner radar. In addition, the MRR may alternatively be installed on a side of the vehicle body or four corners of the vehicle body, and the SRR may alternatively be installed on the front or the rear of the vehicle body.

The radar may be classified based on a modulation manner (or a radiation manner) of an electromagnetic wave of the radar. The modulation manner of the electromagnetic wave of the radar includes a pulse manner and a continuous wave manner. Therefore, the radar may be classified into a pulse radar and a continuous wave radar. The continuous wave manner may be further classified into frequency-shift keying (FSK), phase shift keying (PSK), a constant-frequency/single-frequency continuous wave (CW), a frequency-modulated continuous wave (FMCW), multiple frequency-shift keying (MFSK), a phase-modulated continuous wave (PMCW), and the like. Featuring in multi-target detection, a high resolution, and low costs, the FMCW manner has become a mainstream radar modulation manner.

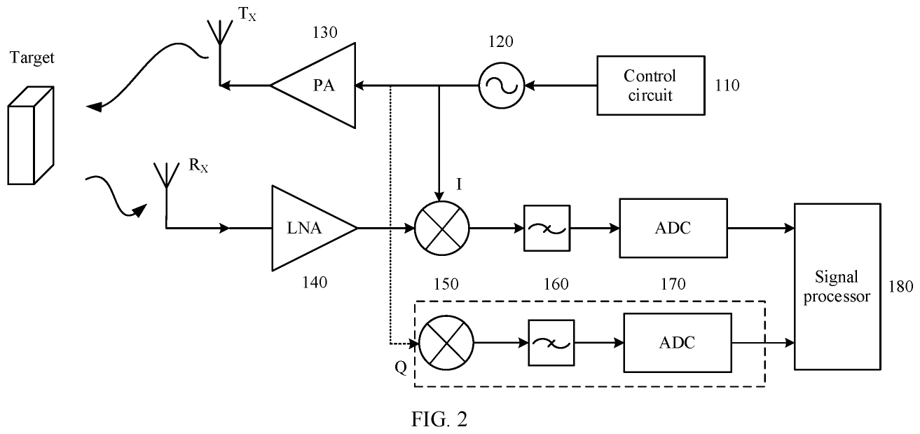

FIG. 2 is a diagram of an architecture of a radar according to an embodiment of the present disclosure.

As shown in FIG. 2, the radar includes a control circuit 110, a signal generator 120, a power amplifier (PA) 130, a low-noise amplifier (LNA) 140, a frequency mixer 150, a filter 160, an analog-to-digital converter (ADC) 170, and a signal processor 180. The signal processor, for example, a digital signal processor (DSP), is usually configured to process a digital signal. The signal generator 120 generates an electromagnetic wave signal (also referred to as a radar signal) waveform under control of the control circuit 110. For example, a radar using an FMCW modulation scheme generates a sawtooth wave or a triangular wave under control of the control circuit 110. The signal generator 120 is, for example, a voltage-controlled oscillator, and the control circuit 110 is configured to generate a control voltage. The generated electromagnetic wave signal waveform is processed through conversion and modulation to a required frequency band, for example, between 76 GHz and 77 GHz, and is radiated to space through a transmit antenna (TX) after being amplified by the PA 130.

An electromagnetic wave signal radiated through the transmit antenna is radiated to a target and then reflected to the space, and is received by a receive antenna (RX) of the radar. After being amplified by the LNA 140, the electromagnetic wave signal is mixed with a reference signal by the frequency mixer 150. The reference signal may usually use the foregoing generated electromagnetic wave signal. After filtering by the filter 160, the frequency mixer 150 may obtain an analog baseband signal, and obtain a digital baseband signal through sampling by the ADC 170. Signal processing of the digital baseband signal is completed in the signal processor 180, to obtain information about a range, a speed, and an angle of the target. In addition, processing such as clustering and/or tracking may be performed based on the obtained information, to further obtain information such as a trajectory, a size, and a type of the target.

The foregoing components of the radar may be integrated based on a requirement to implement miniaturization of the radar. For example, components such as the control circuit 110, the signal generator 120, the PA 130, the LNA 140, the frequency mixer 150, the filter 160, and the ADC 170 may be integrated on at least one chip, for example, integrated into a monolithic microwave integrated circuit (MMIC).

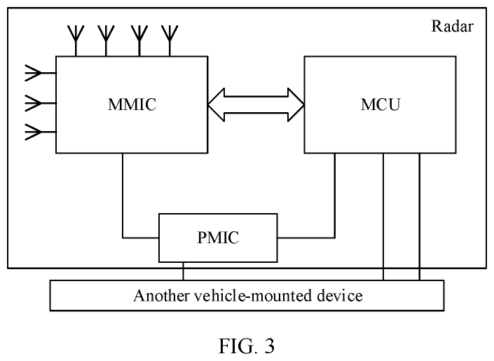

Specifically, FIG. 3 is a diagram of an architecture of a radar according to an embodiment of the present disclosure.

As shown in FIG. 3, the radar includes an MMIC, a microcontroller unit (MCU), and a power management integrated circuit (PMIC). The MMIC may integrate a function of a radio frequency part. The MCU may integrate a function of the foregoing baseband part, for example, integrate a function of the foregoing signal processor. In addition, the MCU may further provide a communication interface for communicating with another vehicle-mounted device. The PMIC is a chip that supplies power to a hardware system of the radar.

For how to improve a detection capability of the radar within a specific angle range in a beam direction of a main lobe of an array, the present disclosure relates to the field of radar technologies, and provides an antenna system, a radar, a terminal device, and a vehicle end, to improve a detection capability of a radar within a specific angle range in a beam direction of a main lobe of an array.

The following describes an antenna system according to embodiments of the present disclosure with reference to the accompanying drawings in embodiments of the present disclosure.

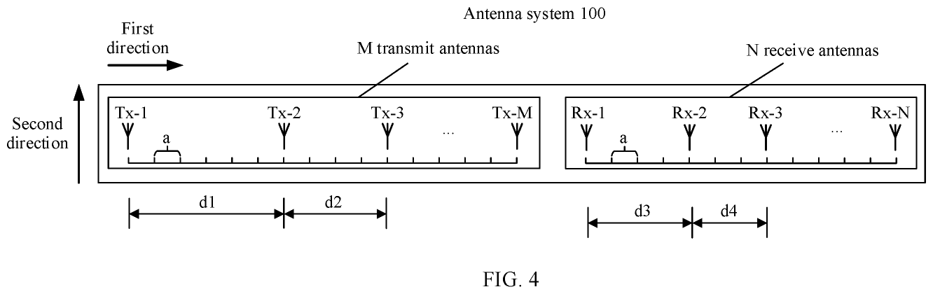

FIG. 4 is a diagram of a structure of a first antenna system according to an embodiment of the present disclosure.

As shown in FIG. 4, an antenna system 100 includes:

M transmit antennas (for example, Tx-1, Tx-2, . . . , and Tx-M) and N receive antennas (for example, Rx-1, Rx-2, . . . , and Rx-N), where M and N are integers greater than 2.

In a first direction, a distance between adjacent antennas varies between two groups of adjacent antennas in the M transmit antennas, and a distance between adjacent antennas varies between two groups of adjacent antennas in the N receive antennas.

The first direction is perpendicular to a second direction. For example, the first direction is a horizontal direction, and the second direction is a vertical direction. Alternatively, the first direction is a vertical direction, and the second direction is a horizontal direction. The first direction and the second direction are not limited in embodiments of the present disclosure, provided that the first direction and the second direction are two directions perpendicular to each other.

The foregoing adjacent antennas are antennas whose positions are adjacent in the first direction. FIG. 4 is used as an example. Tx-1 and Tx-2, Tx-2 and Tx-3, Rx-1 and Rx-2, and Rx-2 and Rx-3 may each be referred to as one group of adjacent antennas. Distances between adjacent antennas among the foregoing four groups of adjacent antennas are d1, d2, d3 respectively, and d4, where d1 is different from d2, and d3 is different from d4.

Optionally, a distance between any group of adjacent antennas is an integer multiple of a first value a.

The “any group of adjacent antennas” may be any group of adjacent antennas in the M transmit antennas, or may be any group of adjacent antennas in the N receive antennas. For example, d1 is six times the first value (6a), d2 is four times the first value (4a), d3 is four times the first value (4a), and d4 is three times the first value (3a).

The first value is related to a wavelength of an electromagnetic wave corresponding to an operating frequency of the antenna system.

The operating frequency of the antenna system may be a frequency of an electromagnetic wave used by the antenna system in an operating process, or may be a frequency of an electromagnetic wave transmitted/received by the antenna system. FIG. 4 is used as an example. The operating frequency of the antenna system may be a frequency of an electromagnetic wave transmitted by the M transmit antennas in a normal operating process of the antenna system, or may be a frequency of an electromagnetic wave received by the N receive antennas.

A frequency and a wavelength of the electromagnetic wave meet the following relationship: c=f·λ, where c represents a propagation speed of the electromagnetic wave in a vacuum, f represents the frequency of the electromagnetic wave, and A represents the wavelength of the electromagnetic wave. The wavelength of the electromagnetic wave corresponding to the operating frequency of the antenna system may be obtained according to c=f·λ.

Optionally, that the first value is related to the wavelength λ may mean that the first value is determined based on the wavelength λ, and a magnitude of the first value changes with λ, or a magnitude of the first value changes proportionally with λ, or the like. For example, the first value a is equal to λ/2, or the first value a is greater than or equal to λ/2.

For example, the operating frequency of the antenna system is 24 GHz. The wavelength corresponding to the operating frequency is 0.125 meters (m). With reference to the foregoing example, the first value may be 0.0625 m, or the first value may be any value greater than or equal to 0.0625 m (for example, 0.07 m or 0.1 m).

For example, the operating frequency of the antenna system is 77 GHz. The wavelength corresponding to the operating frequency is 0.039 m. With reference to the foregoing example, the first value may be 0.02 m, or the first value may be any value greater than or equal to 0.02 m (for example, 0.03 m or 0.1 m).

Optionally, a field of view of the antenna system in the first direction meets the following relationship 1:

$${δ}_{m} = {sin}^{- 1} ( \pm \frac{λ}{a} + sin {δ}_{m} )$$

Herein, δₘ represents two boundary values of the field of view, λ is the wavelength of the electromagnetic wave, and a is the first value.

For example, when a is equal to λ/2, it is derived through calculation that dm is equal to 90° or −90°, indicating that a field of view range is from −90° to 90°. Similarly, for example, when a is equal to 0.7λ, it may be calculated that δₘ is equal to 45.8° or −45.8°, indicating that a field of view range is from −45.8° to 45.8°. It can be learned that a value of a is related to the field of view, and the field of view of the antenna system may be calculated based on the relationship 1.

Optionally, a may be less than λ/2. This is not limited in embodiments of the present disclosure. In combination with the relationship 1, when a is less than λ/2, a field of view range derived through calculation is greater than −90° to 90°.

In a possible implementation, a directional gain pattern corresponding to the M transmit antennas includes at least one first minimum value point, and a directional gain pattern corresponding to the N receive antennas includes at least one second minimum value point. For ease of differentiation, the directional gain pattern corresponding to the M transmit antennas may be referred to as a first gain pattern, and the directional gain pattern corresponding to the N receive antennas may be referred to as a second gain pattern. In addition, both the first gain pattern and the second gain pattern are gain patterns in the first direction.

It may be understood that when an antenna array meets the relationship 1, there is no grating lobe within a field of view range of the antenna array. For example, when a is equal to λ/2, there is no grating lobe within a range from −90° to 90° in the first gain pattern. For another example, when a is equal to 0.7λ, there is no grating lobe within a range from −45.8° to 45.8° in the first gain pattern.

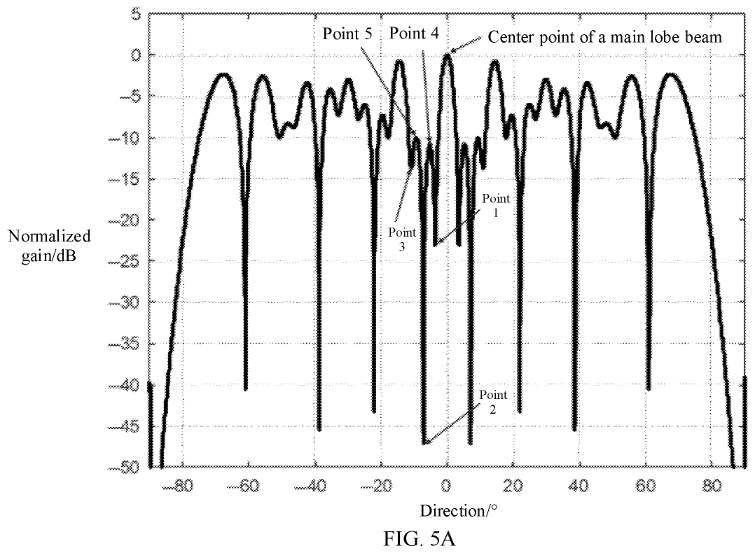

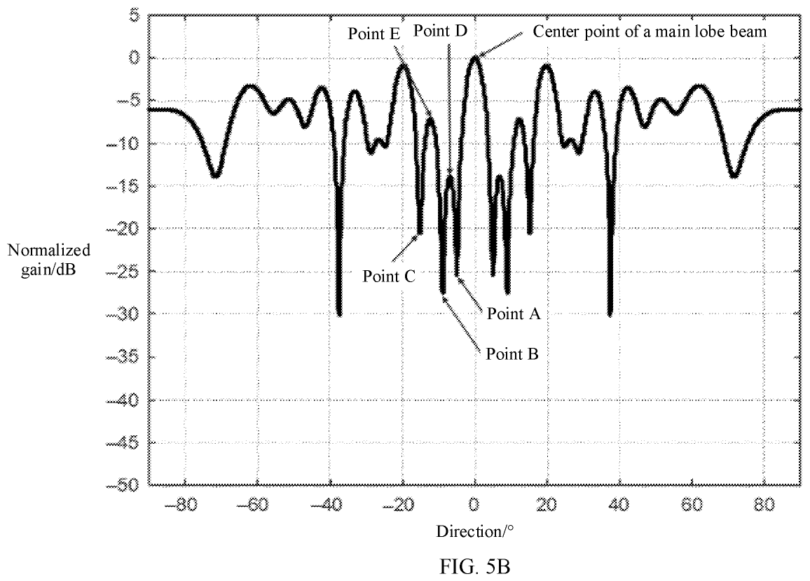

Refer to FIG. 5A and FIG. 5B. FIG. 5A is a diagram of the first gain pattern according to an embodiment of the present disclosure, and is used to show the directional gain pattern corresponding to the M transmit antennas. FIG. 5B is a diagram of the second gain pattern according to an embodiment of the present disclosure, and is used to show the directional gain pattern corresponding to the N receive antennas. In FIG. 5A and FIG. 5B, a horizontal axis represents a direction) (°, and a vertical axis represents a normalized gain (dB).

As shown in FIG. 5A, at least one minimum value point (for example, a point 1, a point 2, a point 3, and the like) is included in FIG. 5A. The minimum value point in FIG. 5A may be referred to as a first minimum value point. As shown in FIG. 5B, at least one minimum value point (for example, a point A, a point B, a point C, and the like) is also included in FIG. 5B. The minimum value point in FIG. 5B may be referred to as a second minimum value point.

Optionally, a direction corresponding to the first minimum value point and a direction corresponding to the second minimum value point are different.

It should be noted that a prerequisite herein is that a direction corresponding to a center point of a main lobe in the first gain pattern and a direction corresponding to a center point of a main lobe in the second gain pattern are the same. For example, the direction corresponding to the center point of the main lobe beam in the first gain pattern and the direction corresponding to the center point of the main lobe beam in the second gain pattern are both 0°.

That the direction corresponding to the first minimum value point and the direction corresponding to the second minimum value point are different may be understood as that a direction corresponding to any first minimum value point and a direction corresponding to any second minimum value point are different. The first minimum value point and the second minimum value point shown in FIG. 5A and FIG. 5B are used as an example. Directions corresponding to the point 1, the point 2, the point 3, the point A, the point B, and the point C are −3.5°, −4.9°, −7.2°, −8.9°, −11.1°, and −15.1° respectively.

The direction corresponding to the first minimum value point and the direction corresponding to the second minimum value point are different, so that a direction corresponding to a maximum value point in the first gain pattern and a direction corresponding to a maximum value point in the second gain pattern may also be different. For example, a point 4 and a point 5 in the first gain pattern and the point D and the point E in the second gain pattern are all maximum value points, and directions corresponding to the point 4, the point 5, the point D, and the point E are different from each other, and are −5.5°, −6.8°, −9.1°, and −12.3° respectively. In this way, no high-gain side lobe beam or a relatively small quantity of high-gain side lobe beams are generated in a directional pattern of a virtual array generated based on the first gain pattern and the second gain pattern, to achieve a good side lobe suppression effect, so as to improve an anti-interference capability of a radar system. It should be noted that making the direction corresponding to the maximum value point in the first gain pattern and the direction corresponding to the maximum value point in the second gain pattern different may mean that directions corresponding to any two maximum value points in the first gain pattern and the second gain pattern are different.

Further, within a first angle range of the center point of the main lobe, the direction corresponding to the first minimum value point and the direction corresponding to the second minimum value point are different.

The first angle range of the center point of the main lobe may be understood as an angle range in which an angle range middle value is the direction corresponding to the center point of the main lobe. For example, the first angle range of the center point of the main lobe meets a relationship 2:

X−Y≤first angle range≤X+Y

Herein, X is the direction corresponding to the center point of the main lobe, and Y is a difference between a boundary value of the first angle range and the direction corresponding to the center point of the main lobe. For example, if the direction corresponding to the center point of the main lobe is 0°, and the difference between the direction corresponding to the center point of the main lobe and an upper boundary/a lower boundary of the first angle range is 90°, the first angle range is from −90° to 90°.

Still with reference to FIG. 5A and FIG. 5B, for example, the first angle range of the center point of the main lobe is from −10° to 10°. In the two patterns, minimum value points within the range from −10° to 10° include the point 1, the point 2, the point A, and the point B, and directions corresponding to the four minimum value points are different.

Optionally, the first angle range [X−Y, X+Y] and a beam width c of the main lobe meet the following relationship 3:

2c≤|(X+Y)−(X−Y)|≤12c

2c≤|2Y|≤12c

For example, if the beam width c of the main lobe is equal to 4.2°, |2Y| is greater than or equal to 8.4°, and |2Y| is less than or equal to 50.4°. That is, a value of the first angle range is from [−4.2°, 4.2°] to [−25.2°, 25.2°]. For example, the value of the first angle range is [−20°, 20°].

In the foregoing, within the first angle range of the center point of the main lobe, the direction corresponding to the first minimum value point and the direction corresponding to the second minimum value point are different. It may also be understood as that when a difference between a direction corresponding to a minimum value point (including the first minimum value point and the second minimum value point) and the direction corresponding to the center point of the main lobe is less than a first angle, the direction corresponding to the first minimum value point and the direction corresponding to the second minimum value point are different. The first angle is greater than 0°. For example, the first angle is 20°. The difference between the direction corresponding to the minimum value point and the direction corresponding to the center point of the main lobe may be understood as an absolute value of the difference between the direction corresponding to the minimum value point and the direction corresponding to the center point of the main lobe. For example, the minimum value point is −20°, the direction corresponding to the center point of the main lobe is 0°, and the difference between the minimum value point and the direction corresponding to the center point of the main lobe is 20°. For another example, the minimum value point is 20°, the direction corresponding to the center point of the main lobe is 0°, and the difference between the minimum value point and the direction corresponding to the center point of the main lobe is still 20°.

For example, the first angle is 10°. In this case, differences between directions corresponding to the point 1, the point 2, the point A, and the point B in FIG. 5A and FIG. 5B and a direction corresponding to a center point of a main lobe are all less than or equal to the first angle, and the directions corresponding to the four minimum value points are different.

In this embodiment of the present disclosure, a distance between adjacent antennas is set to an integer multiple of the first value, and the field of view of the radar system is adjusted by adjusting a ratio of the first value to the wavelength of the electromagnetic wave. In this way, there is no grating lobe within the field of view range, thereby avoiding a case in which a detection result is not unique due to the grating lobe, and reducing a possibility of a detection error of the radar system. Further, within the first angle range of the center point of the main lobe, the direction corresponding to the first minimum value point and the direction corresponding to the second minimum value point are different, so that a good side lobe suppression effect can be achieved within the angle range, and interference introduced by a side lobe can be reduced within the first angle range of the center point of the main lobe, thereby improving a detection capability of the radar within a specific angle range in a beam direction of a main lobe of an array.

Optionally, directions corresponding to first minimum value points within the first angle range of the center point of the main lobe in the first gain pattern are different. As shown in FIG. 5A, the point 1 and the point 2 are first minimum value points within the first angle range of the center point of the main lobe in the first gain pattern, and directions corresponding to the point 1 and the point 2 are different. It may be further understood as that directions corresponding to any two first minimum value points within the first angle range of the center point of the main lobe in the first gain pattern are different.

Optionally, directions corresponding to second minimum value points within the first angle range of the center point of the main lobe in the second gain pattern are different. As shown in FIG. 5B, the point A and the point B are second minimum value points within the first angle range of the center point of the main lobe in the second gain pattern, and directions corresponding to the point A and the point B are different. It may also be understood that directions corresponding to any two second minimum value points within the first angle range of the center point of the main lobe in the second gain pattern are different.

In a possible implementation, the first minimum value point or the second minimum value point is obtained based on the following relationship. A specific implementation process is as follows.

For ease of description, a target minimum value point represents the first minimum value point or the second minimum value point, and a direction corresponding to the target minimum value point is Φ={φ₁, φ₂, φ₃, . . . , φ_{P}}. Herein, φₖ and φₖ₊₁∈Φ, and P is a positive integer, for example, P is equal to 3, 4, or 5. Minimum value points corresponding to φₖ and φₖ₊₁ are adjacent minimum value points in a gain pattern, and φₖ and φₖ₊₁ meet the following relationship 4:

$$\{ \begin{matrix}0 < \vert \vert sin ( {φ}_{k + 1} ) \vert - \vert sin ( {φ}_{k} ) \vert \vert \leq 0.1 \\ {φ}_{k} < {φ}_{k + 1} \\ {φ}_{k + 1} < {γ}_{m} \\ or \\ {γ}_{m} < {φ}_{k}\end{matrix}$$

Herein, γₘ represents the direction corresponding to the center point of the main lobe beam. It may be understood that 0<∥sin(φₖ₊₁)|−|sin(φₖ)∥<0.1 represents that a difference between sine values of directions corresponding to two adjacent target minimum value points belongs to (0, 0.1].

Based on the foregoing relationship 4, a plurality of groups of values of Φ may be calculated, for example, Φ={3.5°, 7.2°, 11.1°}, or Φ={−11.1°, −7.2°, −3.5°}.

Optionally, based on the foregoing relationship 4, Φ and γₘ may further meet the following relationship 5:

When φ₁<φ₂< . . . <φ_{P}<γₘ, 0<∥sin(φ_{P})|−|sin(γₘ)∥≤0.15. In this case, φ_{P} is a direction corresponding to a minimum value point adjacent to the main lobe beam. Controlling a difference between sine values of φ_{P} and γₘ to be within (0, 0.15] can enable a width of the main lobe beam to be narrow, to improve a detection capability of the radar system.

When γₘ<φ₁<φ₂< . . . <φ_{P}, 0<∥sin(φ₁)|−|sin(γₘ)∥≤0.15. In this case, φ₁ is a direction corresponding to a minimum value point adjacent to the main lobe beam. Similarly, controlling a difference between sine values of φ₁ and γₘ to be within (0, 0.15] can enable a width of the main lobe beam to be narrow, to improve a detection capability of the radar system.

Based on the foregoing expression f_{abs(φ,n}_{ᵢ}_{,θ)|}_{_{θ=θm=0°}} (referred to as f in the following) of Φ and a target gain pattern, arrangement of the M transmit antennas or arrangement of the N receive antennas in the first direction may be calculated. A specific implementation process is as follows:

The target gain pattern f may be represented by using the following relationship 6:

$${{f}_{a bs ( φ , {n}_{i} , θ )} \vert}_{θ = {θ}_{m} = 0 °} = \vert {E}_{0} + {\sum }_{i = 1}^{L - 1} {E}_{i} exp ( \frac{2 π d}{λ} * ( sin φ cos θ - sin {γ}_{m} cos {θ}_{m} ) ) j * {n}_{i} \vert = \vert {E}_{0} + {\sum }_{i = 1}^{L - 1} {E}_{i} exp ( \frac{2 π d}{λ} * ( sin φ - sin {γ}_{m} ) * {n}_{i} ) j \vert$$

Herein, θ represents an angle in the target gain pattern in the second direction, and θₘ represents an angle corresponding to the center point of the main lobe beam in the target gain pattern in the second direction. In the case of θ=θₘ=0° in the foregoing relationship 6, a gain pattern represented by the target gain pattern f may be equivalently referred to as a first gain pattern or a second gain pattern. Optionally, alternatively, θ=θₘ may be set to any angle within a field of view range in the second direction, for example, 10° or 15° (a field of view in the second direction is) 45.8°.

φ represents an angle in the target gain pattern in the first direction, and γₘ represents an angle corresponding to the center point of the main lobe beam in the target gain pattern in the first direction. A value of γₘ may be set by a user. For example, γₘ∈[0°, 10°, −10°]. This is not limited in embodiments of the present disclosure. A value of φ may be any value within the field of view range. For example, if the field of view range belongs to [−90°, 90°], the value of φ∈ is [−90°, 90°]. Optionally, alternatively, φ may be a value outside the field of view range. This is not limited in embodiments of the present disclosure.

d represents a minimum interval unit. For example, d may be the first value a, or d may be a subsequent second value b.

The field of view range may be calculated based on the first value a and the relationship 1. For a specific calculation process, refer to the corresponding content above.

nᵢ∈ξ, ξ={n₁, n₂, n₃, . . . , n_{L-1}} represents that when an L^{th} antenna is used as a reference, a distance between an i^{th} antenna and the L^{th} antenna in the first direction is a multiple of the first value, and nᵢ is an integer. The L^{th} antenna may be any antenna in the M transmit antennas, or may be any antenna in the N receive antennas, for example, may be Tx-M or Rx-N shown in FIG. 4. A value of L may be M or N. E₀ represents amplitude excitation of the L^{th} antenna, and Eᵢ represents amplitude excitation of the i^{th} antenna. Values of E₀ and Eᵢ are not limited in embodiments of the present disclosure. For example, both E₀ and Eᵢ are 1.

Further, ξ may be calculated by using the following relationship 7. A specific implementation process is as follows.

The relationship 7 is as follows:

$$\{ \begin{matrix}{\frac{\partial ( {f}^{2} )}{\partial φ} \vert}_{φ = {φ}_{k}} = 0 \\ {\frac{{\partial }^{2} ( {f}^{2} )}{\partial {φ}^{2}} \vert}_{φ = {φ}_{k}} > 0\end{matrix}$$

ξ may be calculated based on Φ determined in combination with the relationship 6, the relationship 7, and the relationship 4. L=4 is used as an example. A value of ξ may be as follows: ξ={6, 10, 15}, ξ={5, 9, 15}, ξ={4, 7, 12}, ξ={5, 8, 12}, ξ={9, 17, 24}, ξ={7, 15, 24}, ξ={7, 12, 18}, or ξ={6, 11, 18}.

It should be noted that, when Φ represents the direction corresponding to the first minimum value point, L=M, and ξ obtained based on the foregoing process represents that a distance between an i^{th} antenna and an L^{th} antenna in the M transmit antennas is nᵢ times the first value. When Φ represents the direction corresponding to the second minimum value point, L=N, and ξ obtained based on the foregoing process represents that a distance between an i^{th} antenna and an L^{th} antenna in the N receive antennas is nᵢ times the first value.

The foregoing Φ represents the direction corresponding to the first minimum value point or the second minimum value point. For ease of differentiation, Φ₁={φ₁₁, φ₁₂, φ₁₃, . . . , φ_{1P1}} may represent the direction corresponding to the first minimum value point, and Φ₂={φ₂₁, φ₂₂, φ₂₃, . . . , φ_{2P2}} may represent the direction corresponding to the second minimum value point. Herein, P1 represents a quantity of first minimum value points, and P2 represents a quantity of second minimum value points. It should be noted that, when φₖ and φₖ₊₁∈Φ₁ or φₖ and φₖ₊₁∈Φ₂, φₖ and φₖ₊₁ also meet the relationship 4.

Values of P1 and P2 are not limited in embodiments of the present disclosure. For example, P1=4, and P2=3, or P1=3, and P2=4. In addition, minimum value points corresponding to adjacent values in Φ₁ and Φ₂ are adjacent minimum value points in the gain pattern. For example, minimum value points corresponding to φ₁₁ and φ₁₂ are adjacent minimum value points in the gain pattern.

Values in Φ₁ and Φ₂ are sequentially arranged in ascending order, to obtain A={α₁, α₁, α₁, . . . , α_{P3}}. It should be noted that, in a process of obtaining A based on Φ₁ and Φ₂, a relationship 8 needs to be met:

$$\{ \begin{matrix}{γ}_{m} < {φ}_{11} , {φ}_{21} \\ or \\ {φ}_{1 P 1} , {φ}_{2 P 2} < {γ}_{m}\end{matrix}$$

Herein, P3=P1+P2, αₓ and αₓ₊₁∈A, and 1≤x≤P3−1. αₓ and αₓ₊₁ meet a relationship 9:

0<∥sin(αₓ₊₁)|−|sin(αₓ)∥≤0.09

Optionally, Φ₃={φ₁₁, φ₁₂, φ₁₃, . . . , φ_{1P4}} may represent the first minimum value point within the first angle range of the main lobe beam, and Φ₄={φ₁₁, φ₁₂, φ₁₃, . . . , φ_{1P5}} may represent the second minimum value point within the first angle range of the main lobe beam. Similarly, values of P3 and P4 are also not limited in this embodiment of the present disclosure. For example, P4=2, and P5=2, or P4=3, and P5=3.

Values in Φ₃ and Φ₄ are sequentially arranged in ascending order, to obtain B={β₁, β₁, β₁, . . . , β_{P6}}. It should be noted that, in a process of obtaining B based on Φ₃ and Φ₄, a relationship 10 needs to be met:

$$\{ \begin{matrix}{γ}_{m} < {φ}_{11} , {φ}_{21} \\ or \\ {φ}_{1 P 4} , {φ}_{2 P 5} < {γ}_{m}\end{matrix}$$

Herein, P6=P4+P5, β_{y} and β_{y+1}∈B, and 1≤y≤P6−1. β_{y} and β_{y+1} meet a relationship 11:

0<∥sin(β_{y+1})|−|sin(β_{y})∥≤0.15

In this embodiment of the present disclosure, a difference between sine values of directions corresponding to two adjacent minimum value points within the first angle range of the main lobe beam is limited to a range of (0, 0.15], so that it can be ensured that directions corresponding to minimum value points do not overlap and are not excessively far away from each other. Therefore, the gain pattern of the virtual array obtained based on the first gain pattern and the second gain pattern has a good side lobe suppression effect within the first angle range, thereby reducing interference introduced by the side lobe, and further improving a detection capability of a radar within a specific angle range in the beam direction of the main lobe of the array.

In a possible implementation, M=N=4, that is, the antenna system shown in FIG. 4 includes four transmit antennas and four receive antennas. A distance between adjacent antennas varies between two groups of adjacent antennas in the four transmit antennas, and a distance between adjacent antennas varies between two groups of adjacent antennas in the four receive antennas. Field of view ranges of the four transmit antennas and the four receive antennas meet the relationship 1, and minimum value points in gain patterns corresponding to the four transmit antennas and the four receive antennas meet the relationship 4, the relationship 10, or the relationship 11.

Next, this embodiment of the present disclosure provides four specific design solutions with reference to the antenna system shown in FIG. 4. It should be noted that the following four design solutions only indicate design solutions of the four transmit antennas and the four receive antennas in the antenna system in the first direction when M=N=4. For a design solution in the second direction, details are not described in the following four solutions.

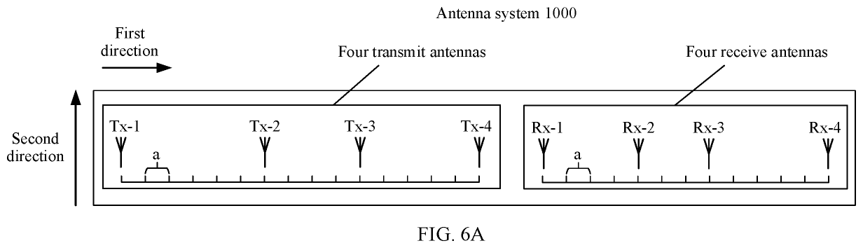

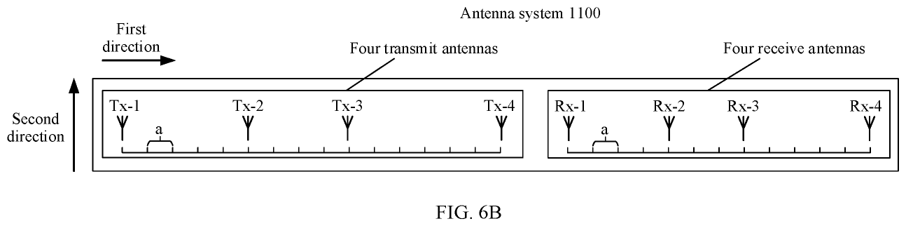

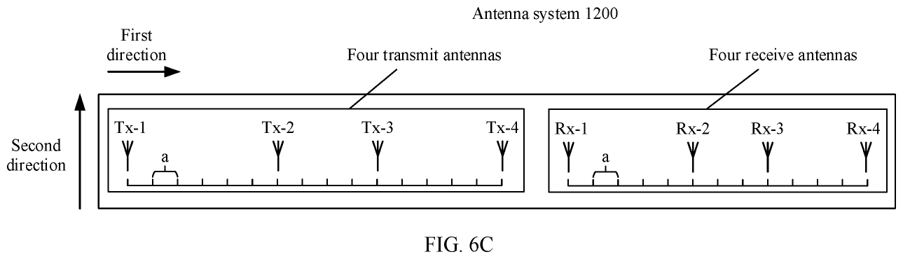

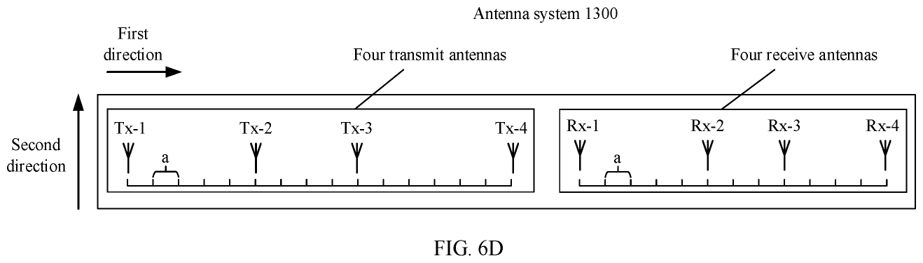

Solution 1: A ratio of distances between adjacent antennas among all groups of adjacent antennas in the four transmit antennas is any one of the following: 6:4:5 or 5:4:6, and a ratio of distances between adjacent antennas among all groups of adjacent antennas in the four receive antennas is any one of the following: 4:3:5 or 5:3:4. In this way, four different cases may be obtained. For details, refer to FIG. 6A to FIG. 6D. FIG. 6A to FIG. 6D are diagrams of several antenna systems according to embodiments of the present disclosure.

Refer to FIG. 6A. In an antenna system 1000 shown in FIG. 6A, spacings between adjacent antennas in the four transmit antennas are in 6:4:5 respectively, and spacings between adjacent antennas in the four receive antennas are in 4:3:5 respectively.

Refer to FIG. 6B. In an antenna system 1100 shown in FIG. 6B, spacings between adjacent antennas in the four transmit antennas are in 5:4:6 respectively, and spacings between adjacent antennas in the four receive antennas are in 4:3:5 respectively.

Refer to FIG. 6C. In an antenna system 1200 shown in FIG. 6C, spacings between adjacent antennas in the four transmit antennas are in 6:4:5 respectively, and spacings between adjacent antennas in the four receive antennas are in 5:3:4 respectively.

Refer to FIG. 6D. In an antenna system 1300 shown in FIG. 6D, spacings between adjacent antennas in four the transmit antennas are in 5:4:6 respectively, and spacings between adjacent antennas in four the receive antennas are in 5:3:4 respectively.

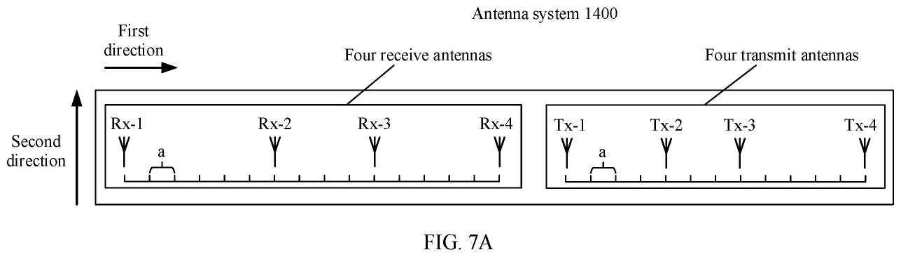

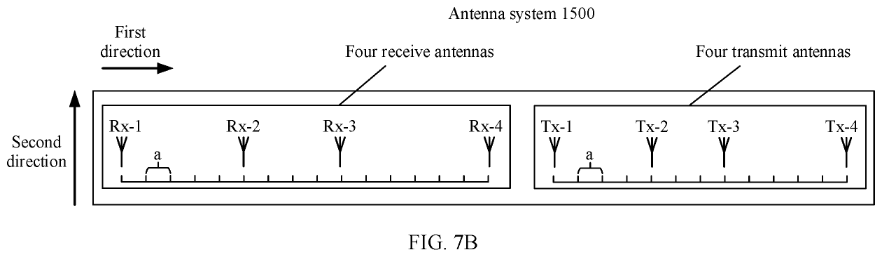

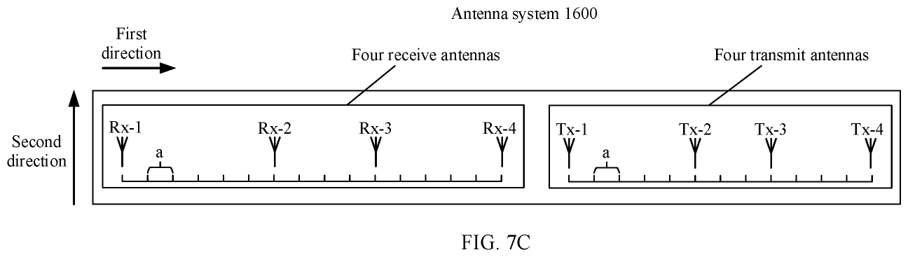

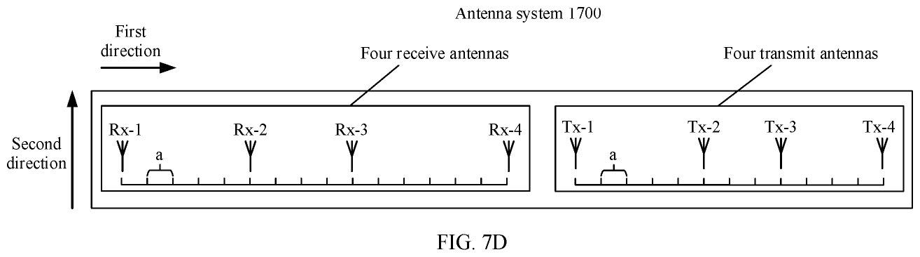

Solution 2: A ratio of distances between adjacent antennas among all groups of adjacent antennas in the four transmit antennas is any one of the following: 4:3:5 or 5:3:4, and a ratio of distances between adjacent antennas among all groups of adjacent antennas in the four receive antennas is any one of the following: 6:4:5 or 5:4:6. In this way, four different cases may be obtained. For details, refer to FIG. 7A to FIG. 7D. FIG. 7A to FIG. 7D are diagrams of several antenna systems according to embodiments of the present disclosure.

Refer to FIG. 7A. In an antenna system 1400 shown in FIG. 7A, spacings between adjacent antennas in the four transmit antennas are in 4:3:5 respectively, and spacings between adjacent antennas in the four receive antennas are in 6:4:5 respectively.

Refer to FIG. 7B. In an antenna system 1500 shown in FIG. 7B, spacings between adjacent antennas in the four transmit antennas are in 4:3:5 respectively, and spacings between adjacent antennas in the four receive antennas are in 5:4:6 respectively.

Refer to FIG. 7C. In an antenna system 1600 shown in FIG. 7C, spacings between adjacent antennas in the four transmit antennas are in 5:3:4 respectively, and spacings between adjacent antennas in the four receive antennas are in 6:4:5 respectively.

Refer to FIG. 7D. In an antenna system 1700 shown in FIG. 7D, spacings between adjacent antennas in the four transmit antennas are in 5:3:4 respectively, and spacings between adjacent antennas in the four receive antennas are in 5:4:6 respectively.

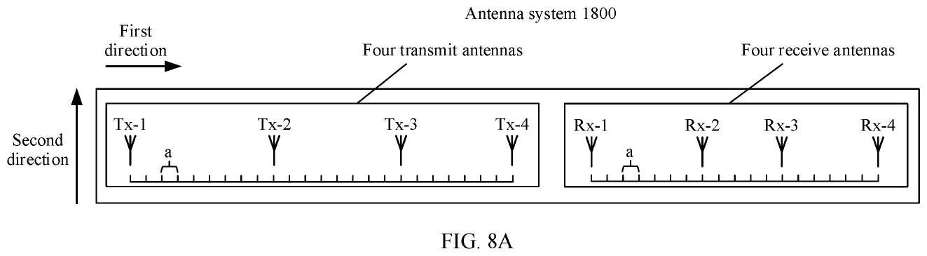

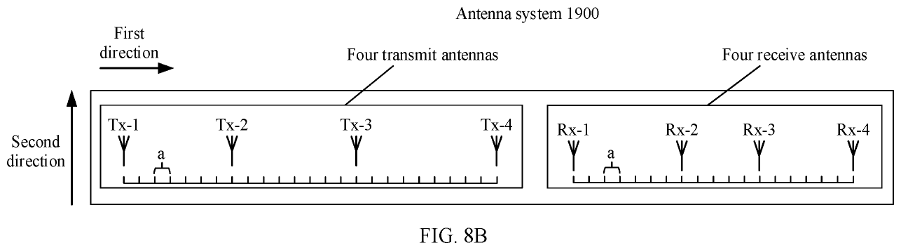

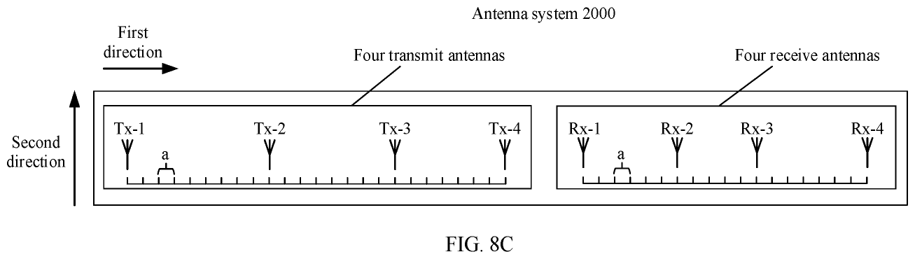

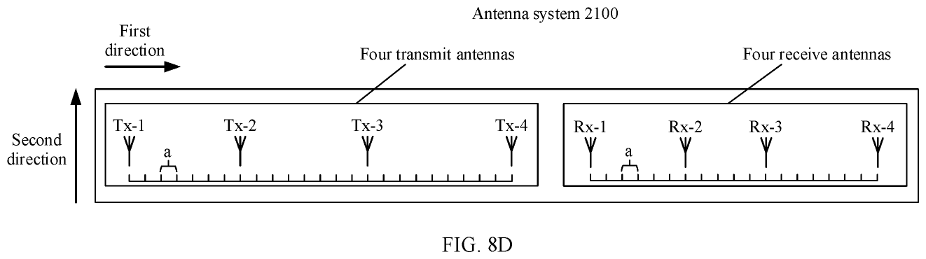

Solution 3: A ratio of distances between adjacent antennas among all groups of adjacent antennas in the four transmit antennas is any one of the following: 9:8:7 or 7:8:9. A ratio of distances between adjacent antennas among all groups of adjacent antennas in the four receive antennas is any one of the following: 7:5:6 or 6:5:7. In this way, four different cases may be obtained. For details, refer to FIG. 8A to FIG. 8D. FIG. 8A to FIG. 8D are diagrams of several antenna systems according to embodiments of the present disclosure.

Refer to FIG. 8A. In an antenna system 1800 shown in FIG. 8A, spacings between adjacent antennas in the four transmit antennas are in 9:8:7 respectively, and spacings between adjacent antennas in the four receive antennas are in 7:5:6 respectively.

Refer to FIG. 8B. In an antenna system 1900 shown in FIG. 8B, spacings between adjacent antennas in the four transmit antennas are in 7:8:9 respectively, and spacings between adjacent antennas in the four receive antennas are in 7:5:6 respectively.

Refer to FIG. 8C. In an antenna system 2000 shown in FIG. 8C, spacings between adjacent antennas in the four transmit antennas are in 9:8:7 respectively, and spacings between adjacent antennas in the four receive antennas are in 6:5:7 respectively.

Refer to FIG. 8D. In an antenna system 2100 shown in FIG. 8D, spacings between adjacent antennas in the four transmit antennas are in 7:8:9 respectively, and spacings between adjacent antennas in the four receive antennas are in 6:5:7 respectively.

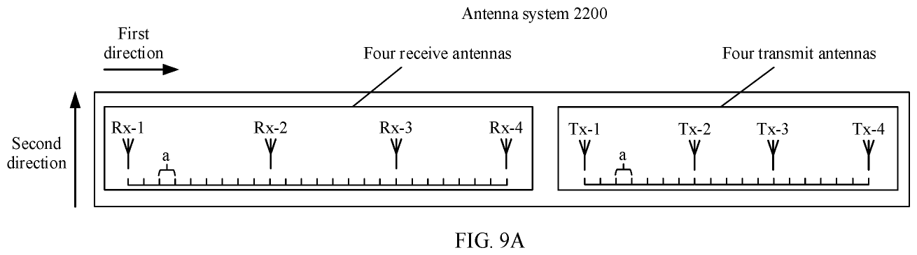

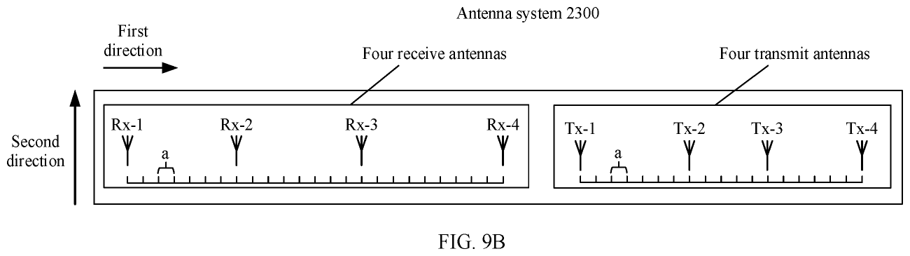

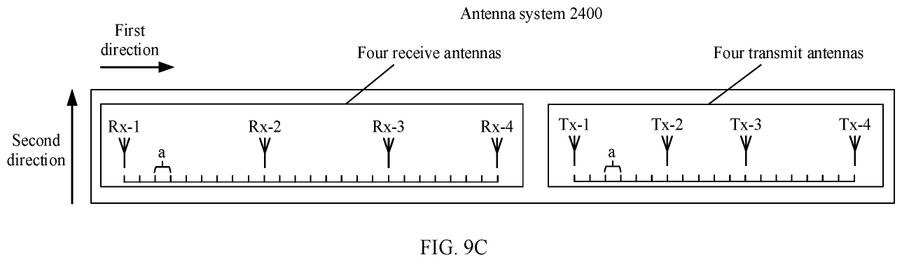

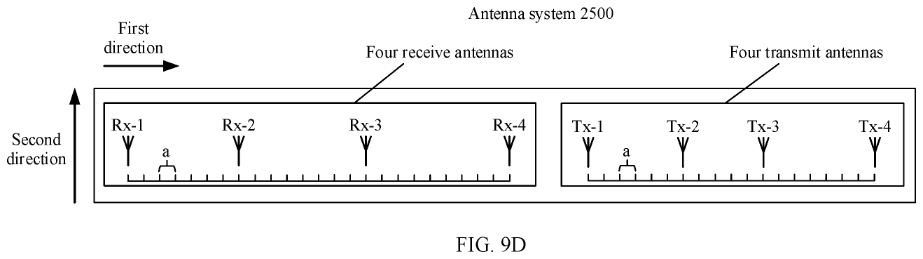

Solution 4: A ratio of distances between adjacent antennas among all groups of adjacent antennas in the four transmit antennas is any one of the following: 7:5:6 or 6:5:7, and a ratio of distances between adjacent antennas among all groups of adjacent antennas in the four receive antennas is any one of the following: 9:8:7 or 7:8:9. In this way, four different cases may be obtained. For details, refer to FIG. 9A to FIG. 9D. FIG. 9A to FIG. 9D are diagrams of several antenna systems according to embodiments of the present disclosure.

Refer to FIG. 9A. In an antenna system 2200 shown in FIG. 9A, spacings between adjacent antennas in the four transmit antennas are in 7:5:6 respectively, and spacings between adjacent antennas in the four receive antennas are in 9:8:7 respectively.

Refer to FIG. 9B. In an antenna system 2300 shown in FIG. 9B, spacings between adjacent antennas in the four transmit antennas are in 7:5:6 respectively, and spacings between adjacent antennas in the four receive antennas are in 7:8:9 respectively.

Refer to FIG. 9C. In an antenna system 2400 shown in FIG. 9C, spacings between adjacent antennas in the four transmit antennas are in 6:5:7 respectively, and spacings between adjacent antennas in the four receive antennas are in 9:8:7 respectively.

Refer to FIG. 9D. In an antenna system 2500 shown in FIG. 9D, spacings between adjacent antennas in the four transmit antennas are in 6:5:7 respectively, and spacings between adjacent antennas in the four receive antennas are in 7:8:9 respectively.

It may be understood that the antenna systems in FIG. 6A to FIG. 6D, FIG. 7A to FIG. 7D, FIG. 8A to FIG. 8D, and FIG. 9A to FIG. 9D are merely described as several example antenna systems, and should not constitute a limitation on the present disclosure. A combined structure of an antenna system obtained based on a reasonable variation of the structure of the antenna system shown in any one of FIG. 6A to FIG. 6D, FIG. 7A to FIG. 7D, FIG. 8A to FIG. 8D, and FIG. 9A to FIG. 9D falls within the protection scope of the present disclosure.

In addition, several specific examples are provided in the present disclosure based on the antenna system shown in FIG. 4 and the antenna systems in FIG. 6A to FIG. 6D, FIG. 7A to FIG. 7D, FIG. 8A to FIG. 8D, and FIG. 9A to FIG. 9D.

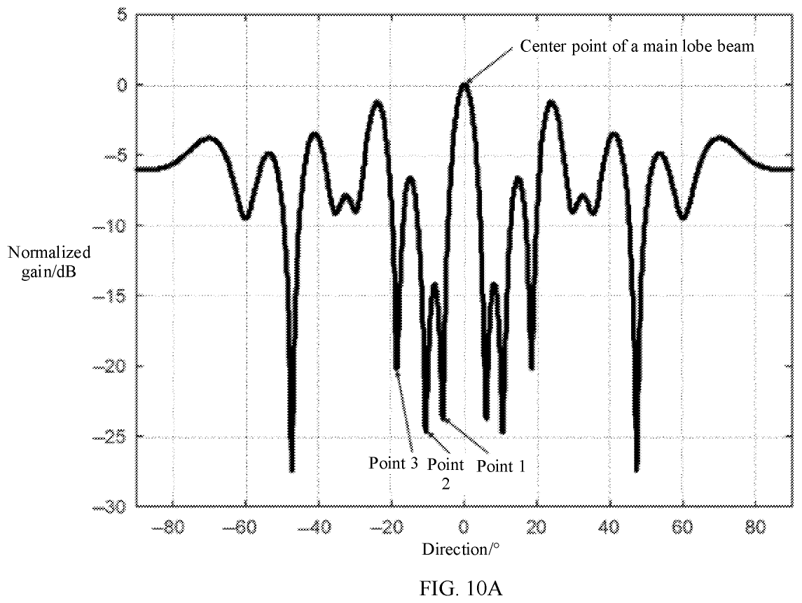

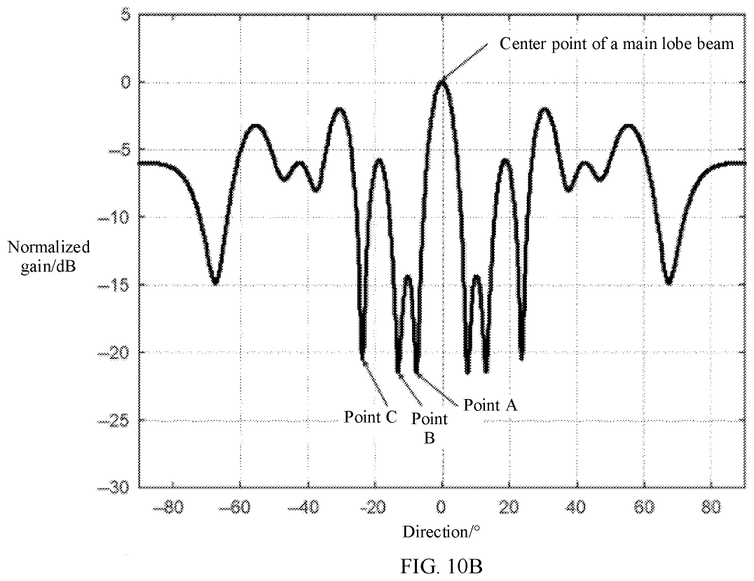

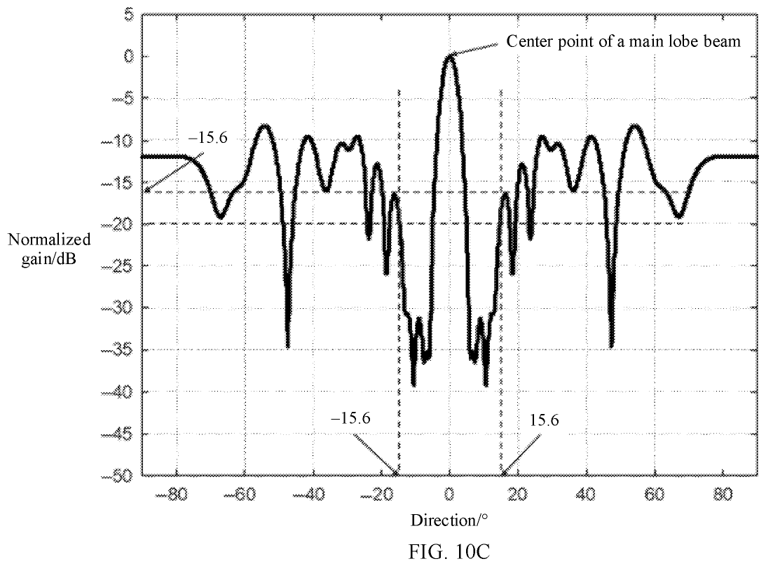

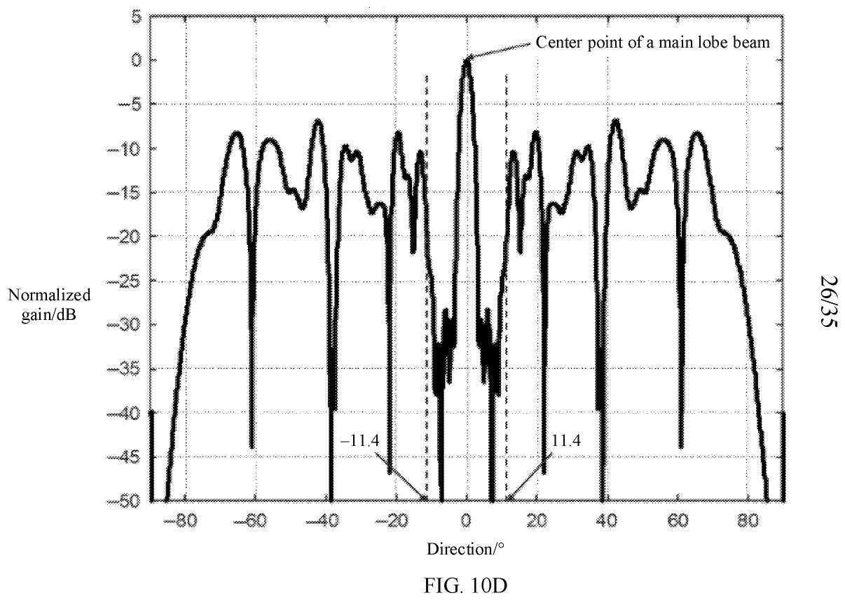

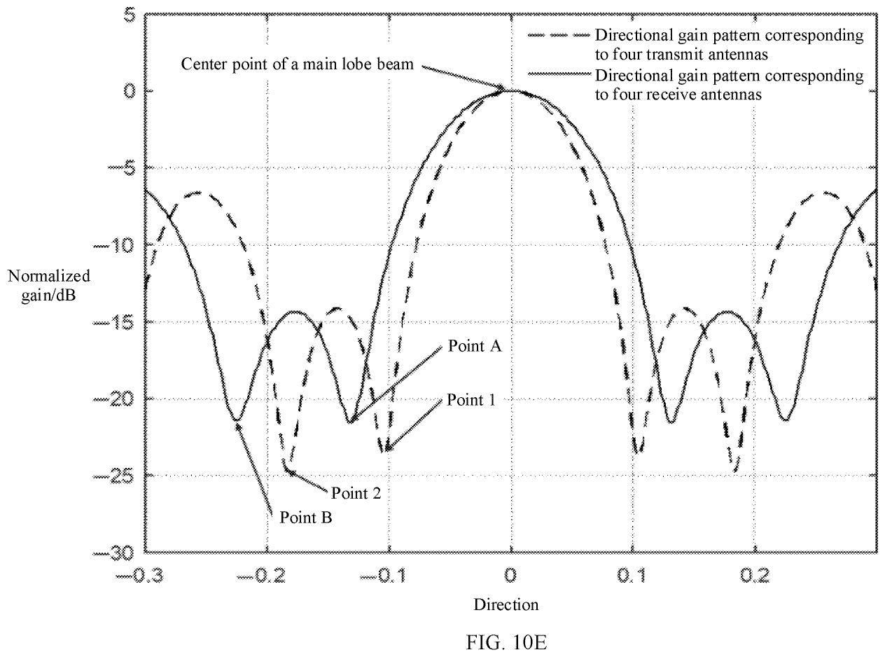

The following provides descriptions with reference to FIG. 10A, FIG. 10B, FIG. 10C, FIG. 10D, and FIG. 10E. In FIG. 10A, FIG. 10B, FIG. 10C, and FIG. 10D, a horizontal coordinate axis represents a direction) (°, and a vertical coordinate axis represents a normalized gain (dB). In FIG. 10E, a horizontal coordinate axis is a sine value of a direction, and a vertical coordinate axis represents a normalized gain (dB).

FIG. 10A is a diagram of a first directional gain pattern according to an embodiment of the present disclosure.

As shown in FIG. 10A, a directional gain pattern corresponding to four transmit antennas in a first direction is shown. Spacings between adjacent antennas in the four transmit antennas are in 6:4:5 respectively, and first value a=λ/2 (a corresponding field of view is [−90°, 90°]).

It can be learned from FIG. 10A that a direction corresponding to a center point of a main lobe beam is 0°, and there is no grating lobe within a field of view range. This can avoid a case in which a detection result is not unique due to the grating lobe.

A point 1, a point 2, and a point 3 shown in FIG. 10A are all minimum value points. Directions corresponding to the point 1, the point 2, and the point 3 are −6.1°, −10.5°, and −18.6° respectively, and the point 1 is a minimum value point adjacent to the main lobe. It can be learned that the directions corresponding to the point 1, the point 2, and the point 3 meet the relationship 4. The direction corresponding to the point 1 and the direction corresponding to the center point of the main lobe beam meet the relationship 5.

In FIG. 10A, a width c of the main lobe beam is 5.4°. Based on the relationship 2c≤|2Y|≤12c, a first angle range of the center point of the main lobe beam may be set to [−20°, 20°].

FIG. 10B is a diagram of a second directional gain pattern according to an embodiment of the present disclosure.

As shown in FIG. 10B, a directional gain pattern corresponding to four receive antennas in a first direction is shown. Spacings between adjacent antennas in the four receive antennas are in 4:3:5 respectively, and first value a=λ/2 (a corresponding field of view is [−90°, 90°]).

It can be learned from FIG. 10B that a direction corresponding to a center point of a main lobe beam is 0°, and there is no grating lobe within a field of view range. This can avoid a case in which a detection result is not unique due to the grating lobe.

A point A, a point B, and a point C shown in FIG. 10B are all minimum value points. Directions corresponding to the point A, the point B, and the point C are −7.6°, −13°, and −23.7° respectively, and the point A is a minimum value point adjacent to the main lobe. It can be learned that the directions corresponding to the point A, the point B, and the point C meet the relationship 4. The direction corresponding to the point A and the direction corresponding to the center point of the main lobe beam meet the relationship 5.

In FIG. 10B, a width c of the main lobe beam is 5.6°. Based on the relationship 2c≤|2Y|≤12c, a first angle range of the center point of the main lobe beam may be set to [−20°, 20°].

Optionally, directions corresponding to the point 1, the point 2, the point 3, the point A, the point B, and the point C in FIG. 10A and FIG. 10B are successively arranged in ascending order. An obtained sequence is: the point 1, the point A, the point 2, the point B, the point 3, and the point C. On a basis of the sequence, directions corresponding to minimum value points meet the relationship 8 and the relationship 9. Minimum value points within the first angle range include the point 1, the point A, the point 2, the point B, and the point 3. On a basis of the sequence, directions corresponding to the minimum value points meet the relationship 10 and the relationship 11.

Optionally, the directional gain patterns shown in FIG. 10A and FIG. 10B meet the relationship 6, and minimum value points in the directional gain patterns meet the relationship 7.

FIG. 10C is a diagram of a third directional gain pattern according to an embodiment of the present disclosure.

As shown in FIG. 10C, a directional gain pattern of a virtual array corresponding to the antenna system 1000 shown in FIG. 6A in a first direction is shown, and first value a=λ/2 (a corresponding field of view is [−90°, 90°]). Spacings between adjacent antennas in four transmit antennas are in 6:4:5 respectively, and spacings between adjacent antennas in four receive antennas are in 4:3:5 respectively.

It can be learned from FIG. 10C that a direction corresponding to a center point of a main lobe beam is 0°, and there is no grating lobe within a field of view range. This can avoid a case in which a detection result is not unique due to the grating lobe.

As shown in FIG. 10C, a first angle range of the main lobe beam is set to [−20°, 20°], and a maximum gain of a side lobe beam within the first angle range is −15.6 dB. A first angle range of the main lobe beam is set to [−15.6°, 15.6°], and a maximum gain of a side lobe beam within the first angle range is −20 dB.

It can be learned that the antenna system shown in FIG. 6A has a good side lobe suppression effect within the first angle range of the center point of the main lobe beam of the array, and can improve a detection capability of the antenna system within the first angle range.

FIG. 10D is a diagram of a fourth directional gain pattern according to an embodiment of the present disclosure.

As shown in FIG. 10D, a directional gain pattern of a virtual array corresponding to the antenna system 2000 shown in FIG. 8C in a first direction is shown, and first value a=λ/2 (a corresponding field of view is [−90°, 90°]). Spacings between adjacent antennas in four transmit antennas are in 9:8:7 respectively, and spacings between adjacent antennas in four receive antennas are in 6:5:7 respectively.

It can be learned from FIG. 10D that a direction corresponding to a center point of a main lobe beam is 0°, and there is no grating lobe within a field of view range. This can avoid a case in which a detection result is not unique due to the grating lobe.

As shown in FIG. 10D, a first angle range of the main lobe beam is set to [−11.4°, 11.4°], and a maximum gain of a side lobe beam within the first angle range is −20 dB.

It can be learned that the antenna system shown in FIG. 8C has a good side lobe suppression effect within the first angle range of the center point of the main lobe beam of the array, and can improve a detection capability of the antenna system within the first angle range.

For more direct display, directions corresponding to minimum value points in FIG. 10A and FIG. 10B meet the relationship 10 or the relationship 11 after being sorted in ascending order. FIG. 10E is a diagram of a fifth directional gain pattern according to an embodiment of the present disclosure.

As shown in FIG. 10E, a black dashed line represents a directional gain pattern corresponding to four transmit antennas (for example, the first directional gain pattern shown in FIG. 10A), and a black solid line represents a directional gain pattern corresponding to four receive antennas (for example, the second directional gain pattern shown in FIG. 10B). It should be noted that, for clearer display, FIG. 10E shows only a pattern within a range from −17.46° to 17.46° (corresponding to −0.3 to 0.3 in FIG. 10E).

For example, a point 1 and a point 2 shown in FIG. 10E are respectively the point 1 and the point 2 shown in FIG. 10A, and a point A and a point B shown in FIG. 10E are respectively the point A and the point B shown in FIG. 10B.

As shown in FIG. 10E, sine values corresponding to the point 1, the point A, the point 2, and the point B are −0.11, −0.13, −0.18, and −0.22 respectively, and meet the relationship 10. Similarly, within the first angle range, sine values corresponding to the point A, the point 2, the point B, the point 3, and the point C also meet the relationship 11. For example, the first angle range is −20° to 20°.

Optionally, the directional gain patterns shown in FIG. 10A and FIG. 10B meet the relationship 6 and the relationship 7.

FIG. 10A to FIG. 10E are merely examples, and should not be construed as a limitation on the implementation solutions of the present disclosure. It may be understood that related parameters in the sixteen antenna systems provided in the foregoing four solutions all meet one or more of the relationship 1 to the relationship 11. For details, refer to the descriptions of FIG. 10A to FIG. 10E.

The following describes, with reference to the accompanying drawings, an arrangement manner of transmit antennas or receive antennas in the antenna system in the second direction by using examples.

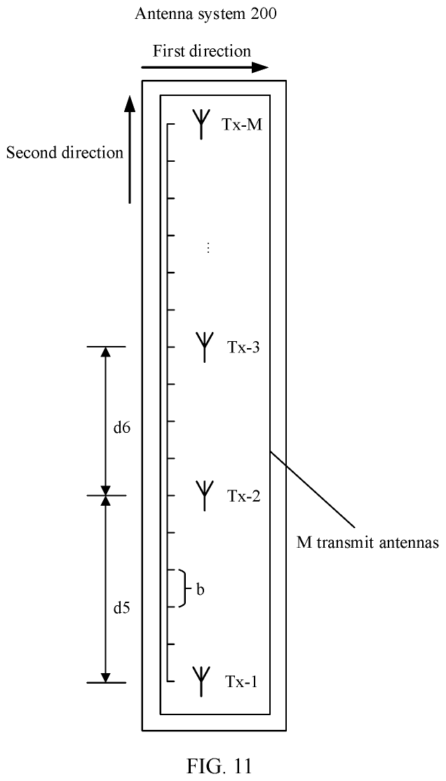

FIG. 11 is a diagram of a structure of a second antenna system according to an embodiment of the present disclosure.

As shown in FIG. 11, an antenna system 200 includes:

M transmit antennas (for example, Tx-1, Tx-2, . . . , and Tx-M), where M is an integer greater than 2.

In a second direction, a distance between adjacent antennas varies between two groups of adjacent antennas in the M transmit antennas.

The second direction is perpendicular to a first direction. For example, the first direction is a horizontal direction, and the second direction is a vertical direction. Alternatively, the first direction is a vertical direction, and the second direction is a horizontal direction. The first direction and the second direction are not limited in embodiments of the present disclosure, provided that the first direction and the second direction are two directions perpendicular to each other.

The foregoing adjacent antennas are antennas whose positions are adjacent in the second direction. FIG. 11 is used as an example. Tx-1 and Tx-2, and Tx-2 and Tx-3 may each be referred to as one group of adjacent antennas. Distances between adjacent antennas between the two groups of adjacent antennas are d5 and d6 respectively, where d5 is different from d6.

Optionally, a distance between any group of adjacent antennas in the M transmit antennas is an integer multiple of a second value b.

For example, d5 is five times the second value (5b), and d6 is four times the second value (4b).

Optionally, the second value is related to a wavelength of an electromagnetic wave corresponding to an operating frequency of the antenna system. For detailed descriptions of the second value, refer to the related descriptions of the first value in FIG. 4.

A value of the second value may be as follows: The second value b is equal to λ/2, the second value b is equal to 0.7λ, the second value b is greater than or equal to λ/2, or the like.

Optionally, a field of view of the antenna system in the second direction also meets the foregoing relationship 1. For example, when b is equal to 0.7λ, it may be calculated, with reference to the foregoing relationship 1, that om may be equal to 45.8° or −45.8°, indicating that a field of view range is from −45.8° to 45.8°.

Optionally, b may alternatively be less than 2/2. This is not limited in embodiments of the present disclosure. In combination with the relationship 1, when b is less than 2/2, the field of view range derived through calculation is greater than −90° to 90°.

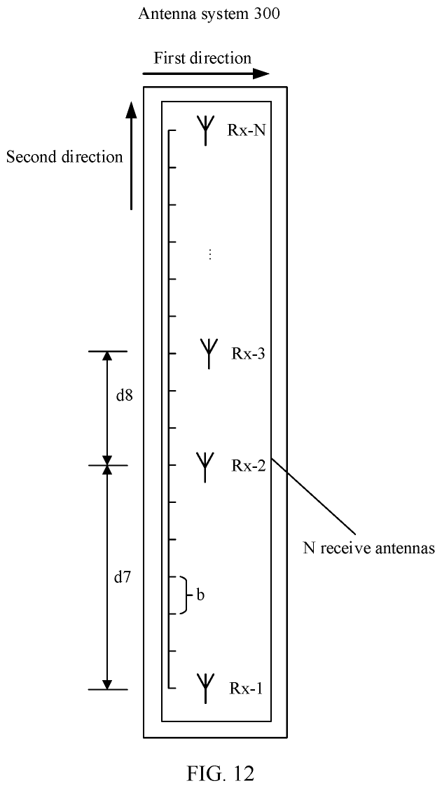

FIG. 12 is a diagram of a structure of a third antenna system according to an embodiment of the present disclosure.

As shown in FIG. 12, an antenna system 300 includes:

N receive antennas (for example, Rx-1, Rx-2, . . . , and Rx-N), where N is an integer greater than 2.

In a second direction, a distance between adjacent antennas varies between two groups of adjacent antennas in the N receive antennas.

The second direction is perpendicular to a first direction. For example, the first direction is a horizontal direction, and the second direction is a vertical direction. Alternatively, the first direction is a vertical direction, and the second direction is a horizontal direction. The first direction and the second direction are not limited in embodiments of the present disclosure, provided that the first direction and the second direction are two directions perpendicular to each other.

The foregoing adjacent antennas are antennas whose positions are adjacent in the second direction. FIG. 12 is used as an example. Rx-1 and Rx-2, and Rx-2 and Rx-3 may each be referred to as one group of adjacent antennas. Distances between adjacent antennas between the two groups of adjacent antennas are d7 and d8 respectively, where d7 is different from d8.

Optionally, a distance between any group of adjacent antennas in the N receive antennas is an integer multiple of a second value b.

For example, d7 is six times the second value (6b), and d8 is three times the second value (3b).

Optionally, the second value is related to a wavelength of an electromagnetic wave corresponding to an operating frequency of the antenna system. For detailed descriptions of the second value, refer to the related descriptions of the first value in FIG. 11.

A value of the second value may be as follows: The second value b is equal to λ/2, the second value b is equal to 0.7λ, the second value b is greater than or equal to λ/2, or the like.

Optionally, a field of view of the antenna system in the second direction also meets the foregoing relationship 1. For example, when b is equal to 0.7λ, it may be calculated, with reference to the foregoing relationship 1, that om may be equal to 45.8° or −45.8°, indicating that a field of view range is from −45.8° to 45.8°.

Optionally, b may alternatively be less than λ/2. This is not limited in embodiments of the present disclosure. In combination with the relationship 1, when b is less than λ/2, the field of view range derived through calculation is greater than −90° to 90°.

In a possible implementation, minimum value points in gain patterns of the M transmit antennas in FIG. 11 or the N receive antennas in FIG. 12 in the second direction may be limited in combination with the relationship 1 to the relationship 11. For a specific implementation, refer to the foregoing corresponding descriptions. It may be understood that, in combination with the relationship 1 to the relationship 11 are used, for possible beneficial effects, refer to the foregoing corresponding content.

In still another possible implementation, the antenna systems provided in FIG. 4, FIG. 11, and FIG. 12 may be combined with each other. For example, for ease of understanding, it may be considered that the antenna system 200 shown in FIG. 11 further includes N receive antennas. Arrangement manners of the N receive antennas in the first direction and the second direction are not limited. The antenna system 300 shown in FIG. 12 further includes M transmit antennas, and arrangement manners of the M transmit antennas in the first direction and the second direction is not limited. M=N=4 is used as an example, that is, the antenna systems shown in FIG. 4, FIG. 11, and FIG. 12 each include four transmit antennas and four receive antennas. A specific combination manner is as follows.

Combination manner 1: The antenna systems provided in FIG. 4 and FIG. 11 are combined.

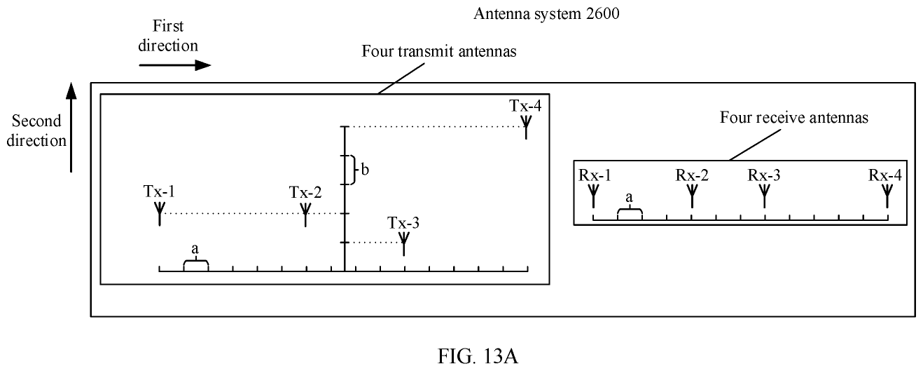

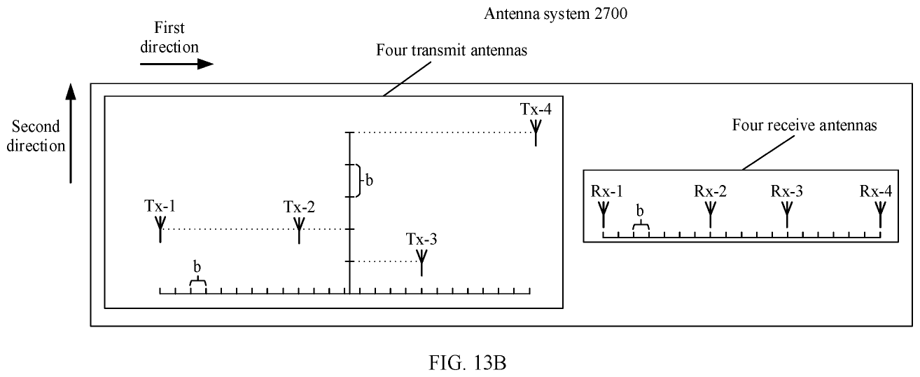

FIG. 13A and FIG. 13B are diagrams of several antenna systems according to embodiments of the present disclosure.

Refer to FIG. 13A. In an antenna system 2600 shown in FIG. 13A, in a first direction, spacings between adjacent antennas in the four transmit antennas are in 6:4:5 respectively, and spacings between adjacent antennas in the four receive antennas are in 4:3:5 respectively. In a second direction, spacings between adjacent antennas in the four transmit antennas are in 1:0:3 respectively. Specifically, in the second direction, a spacing between Tx-3 and Tx-2 is b, a spacing between Tx-2 and Tx-1 is 0, and a spacing between Tx-2 and Tx-4 is 3b. In the second direction, spacings between adjacent antennas in the four receive antennas are not limited in this embodiment of the present disclosure. For example, in the second direction, spacings between adjacent antennas in the four receive antennas may be in 1:0:3 respectively, or in the second direction, spacings between adjacent antennas in the four receive antennas are all 0.

Refer to FIG. 13B. In an antenna system 2700 shown in FIG. 13B, in a first direction, spacings between adjacent antennas in the four transmit antennas are in 9:8:7 respectively, and spacings between adjacent antennas in the four receive antennas are in 7:5:6 respectively. In a second direction, spacings between adjacent antennas in the four transmit antennas are in 1:0:3 respectively. Specifically, in the second direction, a spacing between Tx-3 and Tx-2 is b, a spacing between Tx-2 and Tx-1 is 0, and a spacing between Tx-2 and Tx-4 is 3b. In the second direction, spacings between adjacent antennas in the four receive antennas are not limited in this embodiment of the present disclosure. For example, in the second direction, spacings between adjacent antennas in the four receive antennas may be in 1:0:3 respectively, or in the second direction, spacings between adjacent antennas in the four receive antennas are all 0.

It may be understood that an antenna system with another array arrangement manner may be obtained by combining the antenna system shown in FIG. 4 and the antenna system shown in FIG. 11. FIG. 13A and FIG. 13B are merely examples.

Combination manner 2: The antenna systems provided in FIG. 4 and FIG. 12 are combined.

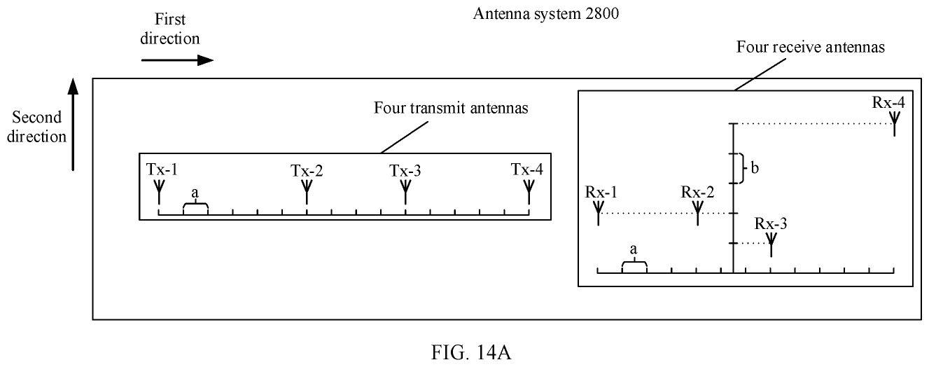

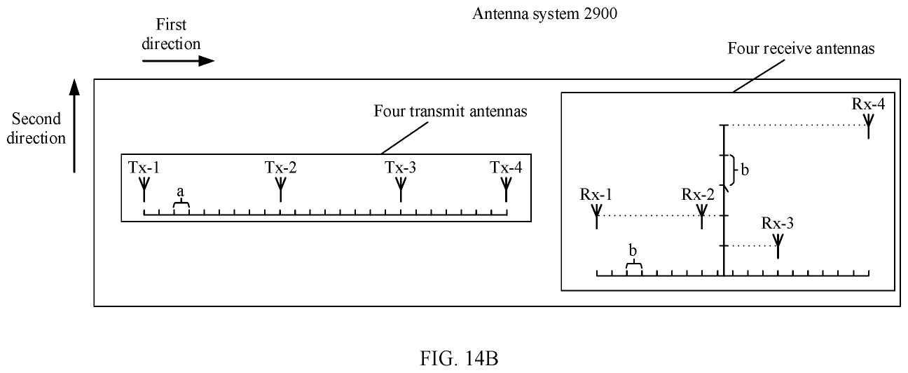

FIG. 14A and FIG. 14B are diagrams of several antenna systems according to embodiments of the present disclosure.

Refer to FIG. 14A. In an antenna system 2800 shown in FIG. 14A, in a first direction, spacings between adjacent antennas in the four transmit antennas are in 6:4:5 respectively, and spacings between adjacent antennas in the four receive antennas are in 4:3:5 respectively. In a second direction, spacings between adjacent antennas in the four receive antennas are in 1:0:3 respectively. Specifically, in the second direction, a spacing between Rx-3 and Rx-2 is b, a spacing between Rx-2 and Rx-1 is 0, and a spacing between Rx-2 and Rx-4 is 3b. In the second direction, spacings between adjacent antennas in the four transmit antennas are not limited in this embodiment of the present disclosure. For example, in the second direction, spacings between adjacent antennas in the four transmit antennas may be in 1:0:3 respectively, or in the second direction, spacings between adjacent antennas in the four transmit antennas are all 0.

Refer to FIG. 14B. In an antenna system 2900 shown in FIG. 14B, in a first direction, spacings between adjacent antennas in the four transmit antennas are in 9:8:7 respectively, and spacings between adjacent antennas in the four receive antennas are in 7:5:6 respectively. In the second direction, spacings between adjacent antennas in the four receive antennas are in 1:0:3 respectively. Specifically, in the second direction, a spacing between Rx-3 and Rx-2 is b, a spacing between Rx-2 and Rx-1 is 0, and a spacing between Rx-2 and Rx-4 is 3b. In the second direction, spacings between adjacent antennas in the four transmit antennas are not limited in this embodiment of the present disclosure. For example, in the second direction, spacings between adjacent antennas in the four transmit antennas may be in 1:0:3 respectively, or in the second direction, spacings between adjacent antennas in the four transmit antennas are all 0.

It may be understood that an antenna system with another array arrangement manner may be obtained by combining the antenna system shown in FIG. 4 and the antenna system shown in FIG. 12. FIG. 14A and FIG. 14B are merely examples.

Combination manner 3: The antenna systems provided in FIG. 11 and FIG. 12 are combined.

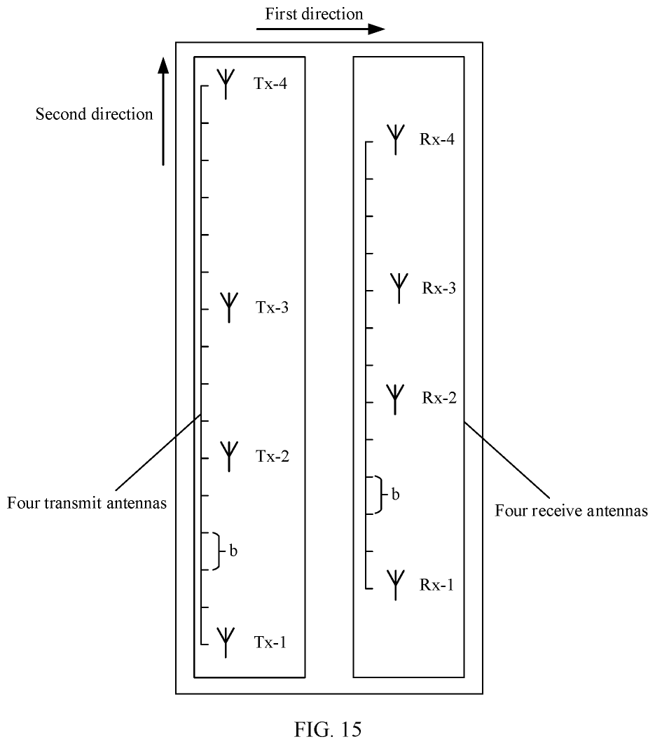

FIG. 15 is a diagram of an antenna system according to an embodiment of the present disclosure.

Refer to FIG. 15. In an antenna system 3000 shown in FIG. 15, in a second direction, spacings between adjacent antennas in four transmit antennas are in 5:4:6 respectively. Spacings between adjacent antennas in four receive antennas are in 5:3:4 respectively. Arrangement manners of the four transmit antennas and the four receive antennas in a first direction are not limited in this embodiment of the present disclosure. For example, in the first direction, spacings between adjacent antennas in the four transmit antennas are in 9:8:7 respectively, and spacings between adjacent antennas in the four receive antennas are in 7:5:6 respectively.

It may be understood that an antenna system with another array arrangement manner may be obtained by combining the antenna system shown in FIG. 11 and the antenna system shown in FIG. 12. FIG. 15 is merely an example.

Combination manner 4: The antenna systems provided in FIG. 4, FIG. 11, and FIG. 12 are combined.

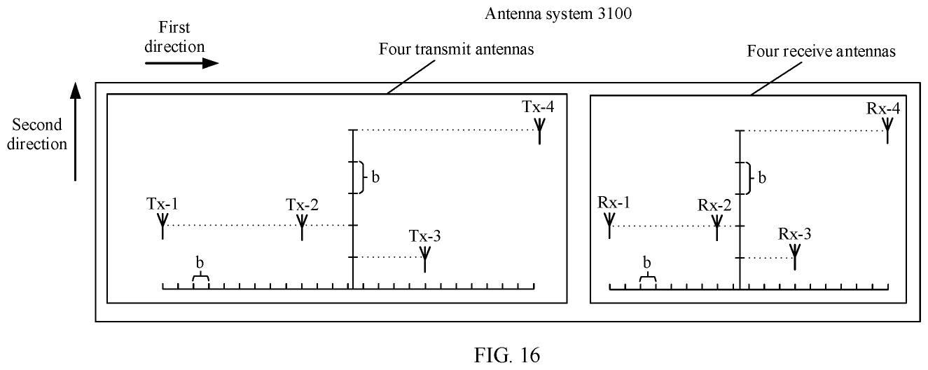

FIG. 16 is a diagram of an antenna system according to an embodiment of the present disclosure.

Refer to FIG. 16. In an antenna system 3100 shown in FIG. 16, in a first direction, spacings between adjacent antennas in the four transmit antennas are in 9:8:7 respectively, and spacings between adjacent antennas in the four receive antennas are in 7:5:6 respectively. In a second direction, spacings between adjacent antennas in the four transmit antennas are in 1:0:3 respectively, and spacings between adjacent antennas in the four receive antennas are in 1:0:3 respectively.

It may be understood that an antenna system with another array arrangement manner may be obtained by combining the antenna systems shown in FIG. 4, FIG. 11, and FIG. 12. FIG. 16 is merely an example.

In the foregoing four provided combination manners, minimum value points in corresponding directional gain patterns of the M transmit antennas and the N receive antennas in the second direction meet one or more of the relationship 1 to the relationship 11. In this case, directions corresponding to minimum value points in the directional gain pattern of the antenna system in the second direction are different, or directions corresponding to minimum value points in the directional gain pattern of the antenna system in the second direction within a first angle range of a beam center point are different. In this way, in a directional gain pattern of a virtual array, a side lobe suppression effect is good within the first angle range of the beam center point, thereby improving a detection capability of the antenna system in the second direction within a specific angle range in a beam direction of a main lobe of an array.

The present disclosure provides a chip. The chip includes the antenna system provided in the present disclosure.

The present disclosure provides a radar or a radar system. The radar or the radar system includes the antenna system or the foregoing chip provided in the present disclosure. It should be noted that there may be a smart sensor that is integrated with a plurality of sensors. When the smart sensor includes a millimeter-wave detection function, the smart sensor may also be referred to as a millimeter-wave radar or a millimeter-wave radar system.

The present disclosure provides a terminal device. The terminal device includes the antenna system provided in the present disclosure. For example, the terminal device may be a transportation tool, for example, a transportation means used in any possible scenario, for example, a vehicle, a truck, an aircraft, an uncrewed aerial vehicle, a slow transport vehicle, a spacecraft, or a ship, or may be any device that can carry a millimeter-wave detection apparatus, for example, a surveying and mapping device. One or more antenna systems provided in the present disclosure are deployed on the terminal device.

The foregoing descriptions are merely specific implementations of the present disclosure, but are not intended to limit the protection scope of this application. Any variation or replacement readily figured out by a person skilled in the art within the technical scope disclosed in the present disclosure shall fall within the protection scope of this application. Therefore, the protection scope of this application shall be subject to the protection scope of the claims.

What is claimed is:

1. An antenna system comprising:
M transmit antennas and N receive antennas, wherein M and N are integers greater than 2,
wherein in a first direction, a first distance between a first pair adjacent antennas is different from a second distance between a second pair of adjacent antennas in the M transmit antennas,
wherein in the first direction, a third distance between a third pair of adjacent antennas is different from a fourth distance between a fourth pair of adjacent antennas in the N receive antennas,
wherein in the first direction, first distances between adjacent antennas in the M transmit antennas or the N receive antennas is an integer multiple of a first value a related to a wavelength of an electromagnetic wave corresponding to an operating frequency of the antenna system,
wherein the M transmit antennas are configured to exhibit a first directional gain pattern comprising a first minimum value point,
wherein the N receive antennas are configured to exhibit a second directional gain pattern comprising a second minimum value point,
wherein the first directional gain pattern and the second directional gain pattern are in the first direction, and
wherein a third direction corresponding to the first minimum value point and a fourth direction corresponding to the second minimum value point are different, wherein the third direction and the fourth direction are within a first angle range [x, y] of a center point of a main lobe of each of the first directional gain pattern and the second directional gain pattern.

2. The antenna system of claim 1, wherein the first value a satisfies the following condition: a≥λ/2, and wherein λ represents the wavelength.

3. The antenna system of claim 1, wherein the first directional gain pattern comprises two first minimum value points adjacent to the main lobe, wherein first directions corresponding to the two first minimum value points are different, wherein the second directional gain pattern comprises two second minimum value points adjacent to the main lobe, and wherein second directions corresponding to the two second minimum value points are different.

4. The antenna system of claim 1, wherein the first minimum value point or the second minimum value point satisfies the following relationship:
$$\{ \begin{matrix}0 < \vert \vert sin ( {φ}_{k + 1} ) \vert - \vert sin ( {φ}_{k} ) \vert \vert \leq 0.1 \\ {φ}_{k} < {φ}_{k + 1} \\ {φ}_{k + 1} < {γ}_{m} \\ or \\ {γ}_{m} < {φ}_{k}\end{matrix} ,$$
wherein φₖ₊₁ and φₖ respectively represent a fifth direction corresponding to a (k+1)th target minimum value point and a sixth direction corresponding to a kth target minimum value point, wherein a target minimum value point is the first minimum value point or the second minimum value point, wherein γₘ represents a seventh direction corresponding to the center point, wherein k∈[1, P−1], wherein P is a quantity of target minimum value points, wherein when the target minimum value point is the first minimum value point, γₘ represents the seventh direction in the first directional gain pattern, and wherein when the target minimum value point is the second minimum value point, γₘ represents the seventh direction in the second directional gain pattern.

5. The antenna system of claim 4, wherein φ₁, φ_{P}, and γₘ satisfy the following relationship:
$$\{ \begin{matrix}{φ}_{P} < {γ}_{m} , 0 < \vert \vert sin ( {φ}_{P} ) \vert - \vert sin ( {γ}_{m} ) \vert \vert < 0.15 \\ {γ}_{m} < {φ}_{1} , 0 < \vert \vert sin ( {φ}_{1} ) \vert - \vert sin ( {γ}_{m} ) \vert \vert < 0.15\end{matrix} ,$$
wherein φ₁ is an eighth direction corresponding to an initial minimum value point in the target minimum value points, and wherein φ_{P} is a ninth direction corresponding to a Pth minimum value point in the target minimum value points.

6. The antenna system of claim 4, wherein A is a set of directions based on a tenth direction corresponding to the first minimum value point and an eleventh direction corresponding to the second minimum value point, wherein A satisfies the following relationship:
$$\{ \begin{matrix}A = \{ {α}_{1} , {α}_{2} , {α}_{3} , … , {α}_{P 3} \} \\ {α}_{x} < {α}_{x + 1} \\ {γ}_{m} < {α}_{1} \\ or \\ {α}_{P 3} < {γ}_{m} \\ x ∈ [ 1 , P3 - 1 ] \\ 0 < \vert \vert sin ( {α}_{x + 1} ) \vert - \vert sin ( {α}_{x} ) \vert \vert \leq 0.09\end{matrix} ,$$
and wherein P3 is a sum of a first quantity of first minimum value points and a second quantity of second minimum value points.

7. The antenna system of claim 1, wherein M=N=4.

8. The antenna system of claim 7, wherein in the first direction, a first ratio of distances between adjacent antennas in the M transmit antennas is 6:4:5 or 5:4:6; and a second ratio of distances between adjacent antennas in the N receive antennas is 4:3:5 or 5:3:4; the first ratio is 9:8:7 or 7:8:9; and the second ratio is 7:5:6 or 6:5:7, the first ratio is 4:3:5 or 5:3:4; and the second ratio is 6:4:5 or 5:4:6; or the first ratio is 7:5:6 or 6:5:7; and the second ratio is 9:8:7 or 7:8:9.

9. The antenna system of claim 1, wherein in a second direction perpendicular to the first direction, a fifth distance between a fifth pair of adjacent antennas is different from a sixth distance between a sixth pair of adjacent antennas in the M transmit antennas, and wherein in the fourth direction, second distances between adjacent antennas in the M transmit antennas is an integer multiple of a second value b related to the wavelength.

10. The antenna system of claim 9, wherein the second value b satisfies the following condition: b≥λ/2, and wherein λ represents the wavelength.

11. The antenna system of claim 10, wherein b=0.7λ.

12. The antenna system of claim 9, wherein M=4, and wherein in the second direction, a ratio of distances among all adjacent antennas in the M transmit antennas is 1:0:3 or 3:0:1.

13. The antenna system of claim 1, wherein the first angle range [x, y] and a beam width c of the main lobe satisfy the following condition: 2c≤|y−x|≤12c.

14. A radar comprising:
a signal generator configured to generate an electromagnetic wave; and
an antenna system comprising:
M transmit antennas and N receive antennas, wherein M and N are integers greater than 2,
wherein in a first direction, a first distance between a first pair adjacent antennas is different from a second distance between a second pair of adjacent antennas in the M transmit antennas,
wherein in the first direction, a third distance between a third pair of adjacent antennas is different from a fourth distance between a fourth pair of adjacent antennas in the N receive antennas,
wherein in the first direction, first distances between adjacent antennas in the M transmit antennas or the N receive antennas is an integer multiple of a first value a related to a wavelength of an electromagnetic wave corresponding to an operating frequency of the antenna system,
wherein the M transmit antennas are configured to exhibit a first directional gain pattern comprising a first minimum value point,
wherein the N receive antennas are configured to exhibit a second directional gain pattern comprising a second minimum value point,
wherein the first directional gain pattern and the second directional gain pattern are in the first direction, and
wherein a third direction corresponding to the first minimum value point and a fourth direction corresponding to the second minimum value point are different, wherein the third direction and the fourth direction are within a first angle range [x, y] of a center point of a main lobe of each of the first directional gain pattern and the second directional gain pattern.

15. The radar of claim 14, wherein the first value a satisfies the following condition: a≥λ/2, and wherein λ represents the wavelength.

16. The radar of claim 14, wherein the first directional gain pattern comprises two first minimum value points adjacent to the main lobe, wherein first directions corresponding to the two first minimum value points are different wherein, the second directional gain pattern comprises two second minimum value points adjacent to the main lobe, and wherein second directions corresponding to the two second minimum value points are different.

17. The radar of claim 14, wherein the first minimum value point or the second minimum value point satisfies the following relationship:
$$\{ \begin{matrix}0 < \vert \vert sin ( {φ}_{k + 1} ) \vert - \vert sin ( {φ}_{k} ) \vert \vert \leq 0.1 \\ {φ}_{k} < {φ}_{k + 1} \\ {φ}_{k + 1} < {γ}_{m} \\ or \\ {γ}_{m} < {φ}_{k}\end{matrix} ,$$
wherein φₖ₊₁ and φₖ respectively represent a fifth direction corresponding to a (k+1)th target minimum value point and a sixth direction corresponding to a kth target minimum value point, wherein a target minimum value point is the first minimum value point or the second minimum value point, wherein γₘ represents a seventh direction corresponding to the center point, wherein k∈[1, P−1], wherein P is a quantity of target minimum value points, wherein when the target minimum value point is the first minimum value point, γₘ represents the seventh direction in the first directional gain pattern, and wherein when the target minimum value point is the second minimum value point, γₘ represents the seventh direction in the second directional gain pattern.

18. The radar of claim 17, wherein φ₁, φ_{P}, and γₘ satisfy the following relationship:
$$\{ \begin{matrix}{ϕ}_{P} < {γ}_{m} , 0 < \vert \vert sin ( {φ}_{P} ) \vert - \vert sin ( {γ}_{m} ) \vert \vert < 0.15 \\ {γ}_{m} < {φ}_{1} , 0 < \vert \vert sin ( {φ}_{1} ) \vert - \vert sin ( {γ}_{m} ) \vert \vert < 0.15\end{matrix} ,$$
wherein φ₁ is an eighth direction corresponding to an initial minimum value point in the target minimum value points, and wherein φ_{P} is a ninth direction corresponding to a Pth minimum value point in the target minimum value points.

19. The radar of claim 17, wherein A is a set of directions based on a tenth direction corresponding to the first minimum value point and an eleventh direction corresponding to the second minimum value point, wherein A satisfies the following relationship:
$$\{ \begin{matrix}A = \{ {α}_{1} , {α}_{2} , {α}_{3} , … , {α}_{P 3} \} \\ {α}_{x} < {α}_{x + 1} \\ {γ}_{m} < {α}_{1} \\ or \\ {α}_{P 3} < {γ}_{m} \\ x ∈ [ 1 , P3 ‐ 1 ] \\ 0 < \vert \vert sin ( {α}_{x + 1} ) \vert - \vert sin ( {α}_{x} ) \vert \vert \leq 0.09\end{matrix} ,$$
and wherein P3 is a sum of a first quantity of first minimum value points and a second quantity of second minimum value points.

20. A terminal device comprising:
a signal generator configured to generate an electromagnetic wave; and
an antenna system comprising:
M transmit antennas and N receive antennas, wherein M and N are integers greater than 2,
wherein in a first direction, a first distance between a first pair adjacent antennas is different from a second distance between a second pair of adjacent antennas in the M transmit antennas,
wherein in the first direction, a third distance between a third pair of adjacent antennas is different from a fourth distance between a fourth pair of adjacent antennas in the N receive antennas,
wherein in the first direction, first distances between adjacent antennas in the M transmit antennas or the N receive antennas is an integer multiple of a first value a related to a wavelength of an electromagnetic wave corresponding to an operating frequency of the antenna system,
wherein the M transmit antennas are configured to exhibit a first directional gain pattern comprising a first minimum value point,
wherein the N receive antennas are configured to exhibit a second directional gain pattern comprising a second minimum value point,
wherein the first directional gain pattern and the second directional gain pattern are in the first direction, and
wherein a third direction corresponding to the first minimum value point and a fourth direction corresponding to the second minimum value point are different, wherein the third direction and the fourth direction are within a first angle range [x, y] of a center point of a main lobe of each of the first directional gain pattern and the second directional gain pattern.
